(19) United States
(12) Patent Application Publication
(10) Pub. No.: US 2006/0263674 A1
(43) Pub. Date: Nov. 23, 2006

(54) Catalyst and process for producing the same, catalytic electrode and process for producing the same, membrane/electrode union, and electrochemical device

(76) Inventors: Mamoru Hosoya, Tokyo (JP); Akinori Kita, Tokyo (JP)

Correspondence Address: ROBERT J. DEPKE;LEWIS T. STEADMAN, ROCKEY, DEPKE, LYONS AND KITZINGER, LLC, SUITE 5450 SEARS TOWER, CHICAGO, IL, 60606-6306, US

(21) Appl. No.: 10/553,241

(22) PCT Filed: Apr. 16, 2004
(86) PCT No.: PCT/JP04/05492

§ 371 Date: Oct. 14, 2005

(30) Foreign Application Priority Data
Apr. 17, 2003 (JP) 2003-112421
May 8, 2003 (JP) 2003-129856
Mar. 12, 2004 (JP) 2004-070191

(51) Int. Cl. H01M 4/96; H01M 4/88; B01J 21/18

(52) U.S. Cl. 429/44; 502/101; 502/180

(57) ABSTRACT

In producing an oxygen reduction catalyst including a nitrogen-containing active carbide by converting either a mixture of a carbonaceous solid raw material (coal-derived binder pitch) and a nitrogen-containing organic compound (melamine or the like) or a nitrogen-containing organic polymer compound (polyacrylonitrile, melamine resin or the like) into a powdery material, baking the powdery material, and subjecting the baked product to steam activation, the presence ratio of nitrogen and the presence ratio of carbon relating to a shake-up process in the surface and the spin density of unpaired electrons showing Curie paramagnetism are controlled to be high, by selection of the baking temperature, the mixing ratio between the carbonaceous solid raw material and the nitrogen-containing organic compound, or the nitrogen-containing organic polymer compound material. In incorporating the catalyst into an electrochemical device, the catalyst and an ion conductive polymer are mixed and a catalyst layer is formed from the mixture so as to make smooth the movement of ions and electrons, and, in applying the catalyst to a polymer electrolyte type fuel cell, an MEA is produced. This makes it possible to provide a catalyst comprised of a nitrogen-containing active carbide and a production method thereof, and an electrochemical device using the catalyst.

### TECHNICAL FIELD

The present invention relates to a catalyst including an activated carbide and a production method thereof, preferable for use as, for example, an oxygen reduction catalyst in a polymer electrolyte type fuel cell or a phosphoric acid type fuel cell, and an electrochemical device using the catalyst. Furthermore, the present invention relates to a catalyst, a catalyst electrode and a production method thereof, a membrane-electrode assembly (MEA), and an electrochemical device, preferable for use in a polymer electrode type fuel cell or the like.

### BACKGROUND ART

A fuel cell is a device in which the heat of combustion generated at the time of oxidation of a fuel is converted into electric energy in high efficiency.

For example, a polymer electrode type fuel cell (hereinafter abridged to PEFC) primarily includes a fuel electrode, an oxygen electrode, and a hydrogen ion (proton) conductive film clamped between the electrodes, and an electromotive force arising from the reaction between a fuel and oxygen is generated between the fuel electrode and the oxygen electrode. On the other hand, in a phosphoric acid type fuel cell (hereinafter abridged to PAFC), a liquid electrolyte containing phosphoric acid is used as the electrolyte.

In the case where the fuel is hydrogen, the hydrogen supplied to the fuel electrode is oxidized on the fuel electrode by the reaction of the following formula (1):
2H₂→4H⁺+4e⁻ (1)
so as to give electrons to the fuel electrode. The resulting hydrogen ions H⁺ are transferred to the oxygen electrode, through the hydrogen ion conductive film in the case of the PEFC, and through the liquid electrolyte in the case of the PAFC.

The hydrogen ions transferred to the oxygen electrode react with oxygen supplied to the oxygen electrode according to the following formula (2):
O₂+4H⁺+4e⁻→2H₂O (2)
to produce water. In this instance, oxygen takes electrons from the oxygen electrode, thereby being reduced.

Thus, hydrogen is oxidized on the fuel electrode, while oxygen is reduced on the oxygen electrode, and, in the fuel cell as a whole, the hydrogen combustion reaction of the following formula (3):
2H₂+O₂→2H₂O (3)
proceeds. In this instance, an electric current flows from the oxygen electrode to the fuel electrode, and electrical energy can be taken out of the fuel cell.

The reactions of the formulas (1) and (2) are reactions which spontaneously proceed, but are high in activation energy. Therefore, in order to realize a sufficient reaction rate at a general operating temperature of a PEFC or PAFC, assist by a catalyst such as platinum may be needed. Accordingly, in many PEFCs and PAFCs, an electrode formed by supporting a catalyst, such as platinum and platinum alloy, on acetylene black, activated carbon or the like, and applying the resulting material to a surface of a carbon-based conductive porous support, such as carbon sheet and carbon cloth, is used as the fuel electrode and as the oxygen electrode (see Japanese Patent Laid-open No. 2000-353528 (pages 6 and 7; FIG. 1)).

FIGS. 16A and 16B show one example of an electrode and the like used in the PEFC according to the related art, in which FIG. 16A is a general sectional view of an electrode and a hydrogen ion conductive film, and FIG. 16B is a general sectional view of a membrane-electrode assembly (MEA).

In an oxygen electrode 151, an oxygen reduction catalyst layer 51a including a mixture of a catalytically active metal, such as platinum and platinum alloy, with a hydrogen ion conductive polymer material such as a perfluorosulfonic acid resin (for example, Nafion(R) (commercial name) produced by du Pont) is formed on a surface of a conductive porous support 151b such as carbon sheet and carbon cloth.

Also, in a fuel electrode 153, a hydrogen oxidation catalyst layer 53a including a mixture of a catalytically active metal, such as platinum and platinum alloy, with a hydrogen ion conductive polymer material such as Nafion(R) is formed on a surface of a conductive porous support 153b such as carbon sheet and carbon cloth.

The catalyst layers 151a and 153a are each formed, for example, by a method in which a carbon powder carrying a platinum-based catalyst thereon and a powder of a hydrogen ion conductive polymer material such as a perfluorosulfonic acid resin are dispersed in a solvent such as ethanol, to obtain a slurry (suspension)-like matter, which is applied to a carbon sheet or the like, and the solvent is evaporated off. The application is conducted by screen printing, a spraying method, a doctor blade method or the like.

Ordinarily, the fuel electrode 153 and the oxygen electrode 151 are joined to each other with a hydrogen ion conductive polymer electrolyte membrane 152 such as Nafion(R) clamped therebetween, to form a membrane-electrode assembly (MEA) 154, which is used in the PEFC or the like. As above-mentioned, the electrode surface to be joined to the hydrogen ion conductive polymer electrolyte film 152 is also provided thereon with the catalyst layer containing the hydrogen ion conductive polymer material which is the same as above, before the joining, so that it is possible to form a favorable joint surface through which hydrogen ions and electrons can move smoothly. The formation of the MEA is indispensable to enhance the performance of the PEFC or the like. Besides, when the perfluorosulfonic acid resin, such as Nafion(R), or the like is used as the hydrogen ion conductive polymer material, both surface layers of the membrane exposed directly to the electrode reaction are formed of a material excellent in chemical stability, so that an electrochemical device with excellent durability can be realized.

At present, the PEFCs are being energetically developed as a power supply for automobiles, outdoor power generation systems, portable apparatuses and the like. However, the PEFCs at present are very high in manufacturing cost, and they are higher than internal combustion engines by a factor of two orders, when compared in the manufacturing cost required for generating the same output. The principal cause of the high cost resides in the high costs of three components, i.e., electrode catalyst, hydrogen ion conductive membrane, and bipolar plate (so-called separator).

Of the above-mentioned three components, the hydrogen ion conductive membrane and the bipolar plate will highly possibly be lowered in cost considerably, due to the effects of mass production and price competitions between the makers, but a reduction in cost by the mass production effect cannot be expected as to the electrode catalyst. This is because platinum, which is expensive, is used as the electrode catalyst in most PEFCs.

In addition, the production of platinum in the natural world is no more than about 168 t a year (as of 1998). On the other hand, there is a trial estimation that the demand for platinum as electrode catalyst will be 40 to 80 t if electric cars with a PEFC of an output of about 50 kW mounted thereon are manufactured in a number of two millions a year; therefore, there is a fear of a steep rise in platinum price in the future, due to such a demand for fuel cells.

Accordingly, it is an extremely important problem in putting the PEFC into practical use to reduce the amount of platinum used as electrode catalyst in the fuel cell, or to develop an electrode catalyst which can be formed without using a noble metal such as platinum.

It is also an extremely important problem in putting the PEFC into practical use to make a progress in the technology of MEA and the like so as thereby to not only reduce the amount of platinum used as electrode catalyst in the fuel cell but also develop an electrode catalyst which can be formed without using a noble metal such as platinum.

Meanwhile, of various carbon materials, those which are conductive are widely used as electrode material, and those which are porous such as activated carbon are used as catalyst or carrier of catalyst. In the PEFCs, for example, the electrode catalyst having platinum or the like carried on acetylene black, activated carbon or the like is used, as above-described. It is known that activated carbon does not have any catalytic action on the reduction of hydrogen but it has a medium level of catalytic action on the reduction of oxygen. Moreover, it is widely known that there are cases where rather a carbide itself such as activated carbon than a carbide with nitrogen contained therein shows a better catalytic activity. Paying attention to these facts, a proposal has been made in which activated carbon enhanced in catalytic activity by containing nitrogen therein is synthesized and the activated carbon thus treated is applied as an oxygen reduction catalyst in an oxygen electrode of a fuel cell (see Japanese Patent Laid-open No. Sho 47-21388 (pages 1 to 6; FIG. 1)).

### DISCLOSURE OF INVENTION

In an example of Japanese Patent Laid-open No. Sho 47-21388, it is described that polyacrylonitrile is used as a nitrogen-containing organic polymer which can be carbonized, it is dissolved into a concentrated solution of zinc chloride under heating, the resulting highly viscous solution is gradually heated at a fixed temperature rise rate of 2° C./min in a nitrogen stream, and, when the temperature has reached 1000° C., the matter under treatment is baked by maintaining it at the fixed temperature for one hour, to synthesize a nitrogen-containing carbide. Then, it is described that when the carbide was ground to obtain a carbide powder and an oxygen electrode of a fuel cell was produced by use of the carbide powder, the oxygen electrode showed good characteristics.

Generally, it is said that the effect of nitrogen on the catalytic action of activated carbon arises from alteration of chemical properties of the surface. It is not known at all, however, what surface structure contributes to the catalytic action, in relation to the catalytic action of activated carbon on the reduction of oxygen.

Japanese Patent Laid-open No. Sho 47-21388 describes an example in which changes in the concentration and amount of zinc chloride lead to changes in the characteristics of the oxygen electrode, an example in which the characteristics are enhanced when the raw material is changed to a mixture of acrylonitrile and melamine or when the synthesized powdery carbide is treated with ammonia, and the like, which implies that various factors relate to the catalytic action of the powdery carbide in a complicated way. Besides, in relation to the powdery carbide synthesized by the method described in Japanese Patent Laid-open No. Sho 47-21388, it is also unclear how the residue of salts such as zinc chloride influence the characteristic of the product.

In consideration of the foregoing, the present inventors, paying attention to the bond state of carbon in the carbide catalysts, also have invented a nitrogen-containing activated carbon catalyst having a catalytic action on the oxygen-reducing reaction (Japanese Patent Application No. 2003-112421; the invention pertaining to this application will be referred to as precedent application invention). By use of this nitrogen-containing activated carbon catalyst, it is possible to obtain a catalyst without using platinum, and to remarkably lower the manufacturing cost of fuel cell. However, the catalytic performance of the nitrogen-containing activated carbon catalyst is not high as compared with that of platinum-based catalysts. Therefore, in order to enhance the power generation characteristics of a PEFC or PAFC, it may be necessary to increase the quantity of electricity generated per unit area of electrode by increasing the amount of the catalyst contained per unit area of electrode, i.e., the thickness of the catalyst layer. However, in the method of producing the catalyst layer by the conventional applying (coating) process mentioned above, the amount of the catalyst which can be deposited by one applying (coating) operation is small, the number of repetitions of the applying (coating) operation is limited, and, therefore, the method is not suited to the formation of a thick catalyst layer.

In consideration of the above-mentioned circumstances, it is an object of the present invention to provide a catalyst including an active carbide and a production method thereof, preferable for use as, for example, an oxygen reduction catalyst in a polymer electrolyte type fuel cell and a phosphoric acid type fuel cell, and an electrochemical device using the catalyst.

Furthermore, in consideration of the above-mentioned circumstances, it is an object of the present invention to provide a catalyst, a catalyst electrode and a production method thereof, a membrane-electrode assembly, and an electrochemical device which are preferably applicable to a polymer electrode type fuel cell and the like.

The present inventors have made various investigations in order to attain the above objects, and, as a result of the investigations, have found out that certain kinds of carbon materials have a catalytic activity effective for use as an oxygen reduction catalyst or the like.

Specifically, the present invention pertains to a catalyst including a material which contains carbon and nitrogen and in which the presence ratio of carbon relating to a shake-up process is controlled, and pertains to a catalyst comprised of activated carbon so controlled that, in measurement of electron spin resonance, first unpaired electrons with a g value of 1.9930 to 2.0000 are contained in a spin density of not more than 3.1×10¹⁹/g, and second unpaired electrons with a g value of 2.0020 to 2.0026 are contained in a spin density of not less than 6.0×10¹⁴/g.

In addition, the present invention pertains to a method of producing a catalyst, including the steps of baking a material containing carbon and nitrogen as component elements, and subjecting the resulting baked product to steam activation, wherein the presence ratio of carbon relating to a shake-up process and/or the spin density of first unpaired electrons with a g value of 1.9980 to 2.0000 and the spin density of second unpaired electrons with a g value of 2.0020 to 2.0026 are controlled.

Furthermore, the present invention pertains to an electrochemical device including a plurality of electrodes, and an ion conductor clamped between the plurality of electrodes, wherein at least one of the plurality of electrodes contains the above-mentioned catalyst.

The above-mentioned carbon relating to the shake-up process is the carbon which gives a spectrum having a peak at 291.8±0.5 eV in measurement of XPS (X-ray Photoelectron Spectroscopy) of 1s electron in the carbon atom. The shake-up process is the phenomenon in which when inner-shell electrons are released in XPS measurement or the like, transition of outer-shell electrons to an excitation energy level occurs through sensing of a change in potential energy due to a rapid change of the effective nuclear charge occurring attendant on the release of the inner-shell electrons. On an apparent basis, the XPS spectrum is observed at a position shifted to the higher energy side by an amount corresponding to the energy required for the transition.

The shake-up process relating the carbon giving the spectrum in a range near 291.8 eV is a so-called π−π* shake-up process, i.e., the phenomenon in which an electron forming a π bond transits to the excitation π level, and this phenomenon is observed in materials in which the gap between valence band and non-occupied band is narrow, such as graphite. Therefore, a carbon material being higher in the content of carbon which relates to the shake-up process and gives an XPS spectrum in the vicinity of 291.8 eV can be said to be a carbon material in which the graphene structure is more developed.

Furthermore, the present invention pertains to a catalyst containing a nitrogen-containing carbonaceous catalyst for accelerating an oxygen-reducing reaction of the following formula:
O₂+4H⁺+4e⁻→2H₂O
and a hydrogen ion conductive polymer material. In addition, the present invention pertains to a catalyst electrode formed by pressurizing and/or heating from a powdery mixture containing the just-mentioned nitrogen-containing carbonaceous catalyst and/or a conductive material carrying said catalyst thereon, and a hydrogen ion conductive polymer material, and the invention pertains also to a method of producing a catalyst electrode, including the steps of preparing a powdery mixture containing the just-mentioned nitrogen-containing carbonaceous catalyst and a hydrogen ion conductive polymer material, and forming said powdery mixture by pressurizing and/or heating.

Furthermore, the present invention pertains to a membrane-electrode assembly wherein the above-mentioned catalyst electrode and a hydrogen ion conductive membrane are joined to each other, and to an electrochemical device wherein the membrane-electrode assembly is used for an electrochemical reaction part.

Since the catalyst according to the present invention contains the nitrogen-containing carbonaceous catalyst and the hydrogen ion conductive polymer material as above-mentioned, gas molecules can move in the inside of the catalyst through internal holes of the carbonaceous material or the voids remaining in the catalyst, the hydrogen ions can move in the inside of the catalyst through the hydrogen ion conductive polymer material, and electrons can move in the inside of the catalyst through the carbonaceous material. Thus, all the substances relating to the oxygen-reducing reaction (the oxygen molecules, hydrogen ions and electrons which react with each other as well as water molecules produced upon the reaction) can easily move between the outside and the inside of the catalyst. Therefore, not only the carbonaceous material located at the surface of the catalyst but also the carbonaceous material present in the inside of the catalyst can effectively display the catalytic action thereof.

Since the catalyst electrode according to the present invention is formed by forming the powdery mixture containing the nitrogen-containing carbonaceous catalyst and the hydrogen ion conductive polymer material as above-mentioned, like in the case of the above-mentioned catalyst, the gas molecules, hydrogen ions and electrons can easily move between the outside and the inside of the catalyst electrode through the internal holes of the carbonaceous material or the voids remaining in the catalyst electrode, through the hydrogen ion conductive polymer material, and through the carbonaceous material, respectively. Therefore, even the carbonaceous material present in the inside of the catalyst electrode can effectively display the catalytic action thereof.

Besides, since the catalyst electrode according to the present invention is formed by pressurizing and/or heating while using the hydrogen ion conductive polymer material as a binder, the thickness and shape of the catalyst electrode are not limited as in the case of the applying (coating) method. Therefore, by enlarging the thickness of the catalyst electrode, for a catalyst low in efficiency per unit volume, it is possible to display a sufficient catalytic action, and to obtain a catalyst electrode better in catalytic performance as compared with the catalyst electrodes with a thin catalyst layer produced by the conventional applying (coating) method. In addition, since the catalyst electrode itself has a stand-alone shape, it does not need a support, and a plurality of the catalyst electrodes differing in forming conditions can easily be used in combination.

The production method according to the present invention is a method of producing the above-mentioned catalyst electrode. Besides, according to the membrane-electrode assembly and the electrochemical device of the present invention, the characteristic features of the catalyst electrode can be effectively displayed on electrochemical reactions.

### BRIEF DESCRIPTION OF DRAWINGS

FIG. 1 is a general sectional view of an apparatus for synthesizing a nitrogen-containing active carbide, based on an embodiment of the present invention;

FIG. 2 is a general sectional view of a fuel cell incorporating an MEA, based on the embodiment of the present invention;

FIG. 3A is a general sectional view showing the configuration of the fuel cell, based on the embodiment of the present invention;

FIG. 3B is an enlarged sectional view of the MEA showing the configuration of the fuel cell, based on the embodiment of the present invention;

FIG. 4 is a graph showing the relationship between output voltage and output density, for fuel cells according to Examples 1 to 5 and 6 of the present invention;

FIG. 5 is a graph showing the relationship between the spin densities of two kinds of unpaired electrons and the presence ratio of nitrogen at the surface, for the nitrogen-containing active carbides according to Examples 1 to 5 and the carbide according to Example 6 of the present invention;

FIG. 6 is a graph showing the temperature dependences of spin density, for two kinds of unpaired electrons contained in the nitrogen-containing active carbide of Example 5 and the unpaired electrons contained in the carbide of Example 7 of the present invention;

FIG. 7 is a graph showing the relationship between output voltage and output density for fuel cells according to Examples 9 and 11 of the present invention;

FIG. 8 is a chemical formula showing the nitrogen species presumed to be present in a nitrogen-containing active carbide;

FIG. 9A is a general sectional view of an electrode and the like, based on a preferred embodiment of the present invention;

FIG. 9B is a general sectional view of an apparatus for synthesizing an MEA nitrogen-containing active carbide in an electrode or the like, based on the preferred embodiment of the present invention;

FIG. 10 is a general sectional view of a fuel cell incorporating the MEA, based on the preferred embodiment of the present invention;

FIG. 11 is a general sectional view showing the configuration of the fuel cell, based on the preferred embodiment of the present invention;

FIG. 12 is a general sectional view of an apparatus for synthesizing a nitrogen-containing active carbide catalyst, based on the preferred embodiment of the present invention;

FIG. 13 is a graph showing the relationship between the surface density of a nitrogen-containing active carbide catalyst and the output density of a fuel cell, according to an embodiment of the present invention;

FIG. 14 is a graph showing the relationship between the mixing ratio of Nafion(R) and the output density of a fuel cell, according to the embodiment of the present invention;

FIG. 15 is a graph showing the relationship between the forming pressure and the output density of the fuel cell, according to the embodiment of the present invention;

FIG. 16A is a general sectional view of an electrode and the like used in a PEFC according to the related art; and

FIG. 16B is a general sectional view of an MEA of an electrode or the like used in the PEFC according to the related art.

### BEST MODE FOR CARRYING OUT THE INVENTION

### First Embodiment

The catalyst according to the present invention is preferably an oxygen reduction catalyst for accelerating the reaction of the following formula:
O₂+4H⁺+4e⁻→2H₂O,
Comprised of a material which contains at least carbon and nitrogen as indispensable component elements and in which the presence ratio of carbon relating to a shake-up process at the surface thereof is controlled.

In addition, the material preferably such that, in measurement of electron spin resonance, the above-mentioned first unpaired electrons show Pauli paramagnetism, and the above-mentioned second unpaired electrons show Curie paramagnetism. As will be detailed in Examples later, the unpaired electrons showing Pauli paramagnetism are unpaired electrons occupying the conduction band and showing delocalization, while the unpaired electrons showing Curie paramagnetism are unpaired electrons localized into a fixed location in the molecule. It is considered that, in the catalyst according to the present invention, a functional carbon material having good electron conductivity and an oxygen reduction catalyst property is realized because the unpaired electrons showing Curie paramagnetism are added to a carbon material containing the unpaired electrons showing Pauli paramagnetism while controlling the spin density thereof.

Besides, the catalyst preferably contains nitrogen atoms in an amount of not less than 0.96 mol %, in terms of atom number percentage at the surface of the oxygen reduction catalyst. The catalyst preferably contains first nitrogen atoms having an N1s electron bond energy of 398.5±0.5 eV in an atom number percentage of not less than 0.22 mol %, second nitrogen atoms having an N1s electron bond energy of 401±0.5 eV in an atom number percentage of not less than 0.53 mol %, and third nitrogen atoms having an N1s electron bond energy of 403.5±0.5 eV in an atom number percentage of not less than 0.21 mol %. These are conditions for enhancing the presence ratio of carbon relating to the shake-up process and for enhancing the spin density of the second unpaired electrons with a g value of 2.0020 to 2.0026.

In the present invention, the catalyst is preferably produced by preparing a nonmetallic material containing at least carbon and nitrogen as component elements, rendering the raw material powdery, baking the powdery material, and subjecting the resulting nitrogen-containing carbide powder to a steam activation treatment. According to this method, the powdery raw material is used, and the baking and the steam activation treatment are conducted at the interface between gaseous phase and solid phase, so that the catalyst is obtained in a powdery form. The powdery form is convenient for forming a catalyst layer by applying the material onto an electrode, or for forming a formed body having a shape suited to utilization thereof.

Specifically, an oxygen reduction catalyst comprised of a nitrogen-containing active carbide is preferably produced by a method in which a mixture of a carbonaceous solid raw material and a nitrogen-containing organic compound or a nitrogen-containing organic polymer compound is made to be powdery, the powdery material is baked, and the resulting nitrogen-containing carbide powder is subjected to steam activation. Here, it is preferable to use a coal-derived binder pitch as the carbonaceous solid raw material and use melamine or hydrazine as the nitrogen-containing organic compound. In addition, it is preferable to use polyacrylonitrile, a melamine resin, nylon, gelatin or collagen as the nitrogen-containing organic polymer compound. Thus, this method permits the use of various materials obtainable in large volume and inexpensively, as the raw material.

In this case, it is preferable that the presence ratio of carbon relating to the shake-up process at the surface and/or the spin density of first unpaired electrons with a g value of 1.9980 to 2.0000 and the spin density of second unpaired electrons with a g value of 2.0020 to 2.0026 are controlled by selecting the baking temperature, and the mixing ratio of the carbonaceous solid raw material and the nitrogen-containing organic compound, or the nitrogen-containing organic polymer material used. For example, the baking and the steam activation are preferably conducted in a high-purity nitrogen stream at a temperature of 1000° C.

In the present invention, it is preferable that an electrochemical device comprising a plurality of electrode and an ionic conductor clamped between the plurality of electrodes is formed, wherein at least one of the plurality of electrodes contains the above-mentioned catalyst. The electrochemical device is preferably configured as a cell, particularly a fuel cell.

In this case, the catalyst is preferably used in combination with an ionic conductive polymer so as to form a surface layer of the plurality of electrodes. In addition, it is preferable that an ionic conductive membrane is clamped between the plurality of electrodes to produce a membrane-electrode assembly (MEA), and the MEA is used for an electrochemical reaction part so as thereby to produce an electrochemical device. This ensures that the movement of hydrogen ions and electrons at the three-phase interface occurs smoothly, and polarization is restrained.

Besides, the electrochemical device is preferably a fuel cell containing the above-mentioned catalyst as an oxygen electrode catalyst.

Now, synthesis of a nitrogen-containing active carbide catalyst and a fuel cell using the catalyst, according to preferred embodiments of the present invention, will be described in detail below referring the drawings.

<Synthesis of Nitrogen-containing Active Carbide Catalyst>

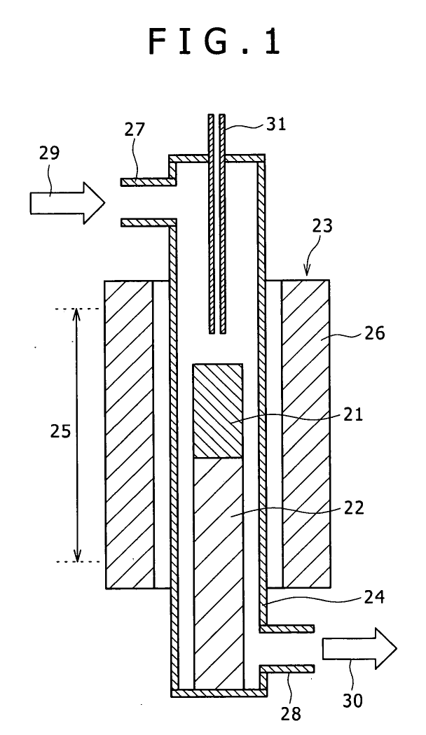

FIG. 1 is a general sectional view of an apparatus for synthesizing a nitrogen-containing active carbide catalyst. A specimen is put in a specimen tube 21, which is placed on a specimen support base 22, the whole thereof is disposed in the inside of a core tube 24 of an electric furnace 23, and the positional adjustment is made so that the specimen is surrounded by a heating temperature zone 25 of the electric furnace 23. The electric furnace 23 is so configured that the gas inside the core tube 24 is heated by passing an electric current to a heater part 26, and the specimen can be heated to a desired temperature by way of the gas. A gas inlet port 27 is provided at an upper portion of the core tube 24, and a gas discharge port 28 is provided at a lower portion of the core tube 24.

In baking the specimen, a high-purity nitrogen gas 29 is introduced through the gas inlet port 27, and an exhaust gas 30 upon reaction is discharged through the gas discharge port 28. The specimen tube 21 is so configured that the nitrogen gas 29 heated to a high temperature flows by or through the specimen, and the specimen is carbonized by heating in the oxygen-free high-purity nitrogen gas atmosphere, to be converted into a carbide.

A water inlet pipe 31 is provided on the upper side of the specimen pipe 21, and water is supplied through this pipe into the core tube 24 at the time of steam activation. The water thus supplied is evaporated in the vicinity of the outlet of the water inlet pipe 31, is carried by the high-purity nitrogen gas stream to the place of the specimen put in the specimen tube 21, and undergoes a hydrothermal reaction, for example, the following reaction:
C+H₂O→CO+H₂
With the carbide there. As a result, the carbide is changed to be porous, with a conspicuous increase in the surface area thereof, so that the gas adsorption performance and the catalytic action of the carbide are remarkably activated.
<Production of Fuel Cell and MEA>

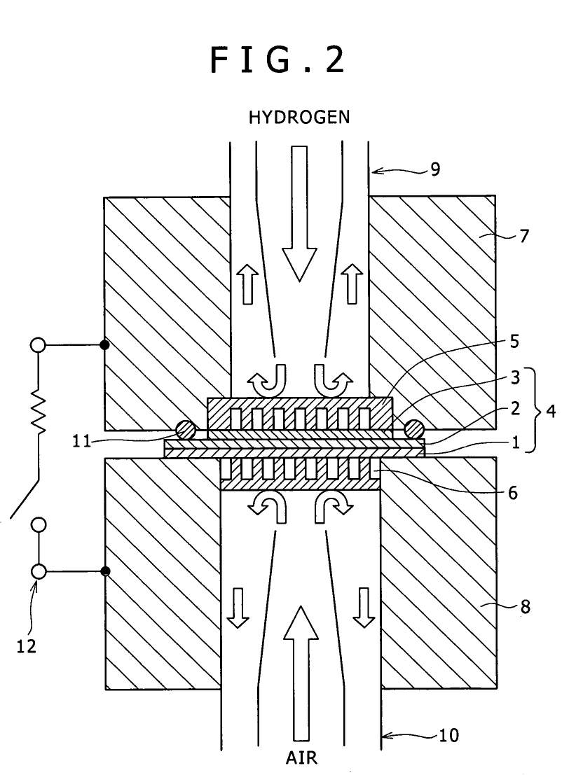

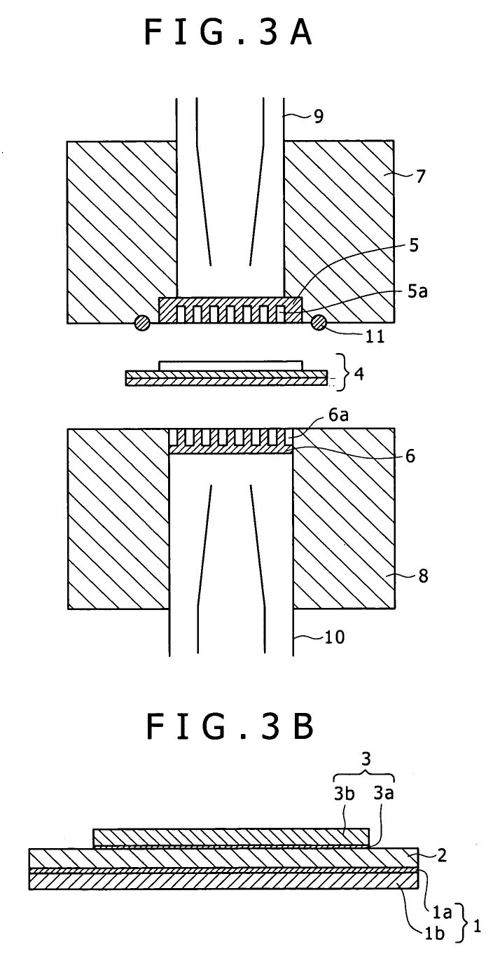

FIG. 2 is a general sectional view showing the configuration of a fuel cell. FIG. 3A is a general sectional view for permitting easy checking of the configuration of the apparatus of FIG. 1 in its partly disassembled state, and FIG. 3B is an enlarged sectional view of a membrane-electrode assembly (MEA) 4. The membrane-electrode assembly (MEA) 4 is formed by joining a fuel electrode 3 and an oxygen electrode 1 respectively to both sides of a hydrogen ion conductive polymer electrolyte membrane 2.

In the apparatus of FIG. 2, the membrane-electrode assembly (MEA) 4 is clamped between a cell upper half 7 and a cell lower half 8, and they as a whole are incorporated into the fuel cell. The cell upper half 7 and the cell lower half 8 are provided respectively with gas supply pipes 9 and 10, and hydrogen is fed through the gas supply pipe 9, while air or oxygen is fed through the gas supply pipe 10. The gases are supplied to the fuel electrode 3 and the oxygen electrode 1 through gas supply parts 5 and 6 which are provided with vent holes (not shown). The gas supply part 5 provides electrical connection between the fuel cell 3 and the cell upper half 7, while the gas supply part 6 provides electrical connection between the oxygen electrode 1 and the cell lower half 8. An O ring 11 for preventing the leakage of hydrogen gas is attached to the cell upper half 7.

Power generation can be effected by closing an external circuit 12 connected to the cell upper half 7 and the cell lower half 8 while supplying the above-mentioned gases. In this instance, on the surface of the fuel electrode 3, hydrogen is oxidized by the reaction of the following formula (1):
2H₂→4H⁺+4e⁻ (1)
so as to give electrons to he fuel electrode 3. The resulting hydrogen ions H⁺ move through the hydrogen ion conductive membrane to the oxygen electrode 1. Here, the fuel electrode 3 may be supplied with methanol as a fuel, in the case of the so-called direct methanol system.

The hydrogen ions having moved to the oxygen electrode 1 react with oxygen supplied to the oxygen electrode 1 according to the following formula (2):
O₂+4H⁺+→4e⁻→2H₂O (2)
to produce water. In this instance, oxygen picks up electrons from the oxygen electrode 1, thereby being reduced.

As the polymer electrolyte membrane 2, any of those which show hydrogen ion conductivity can be used. For example, a separator coated with a hydrogen ion conductive polymer material, and the like can be used. Specific examples of the material usable for the polymer electrolyte membrane 2 include, first, hydrogen ion conductive polymer materials such as perfluorosulfonic acid resin (for example, Nafion(R) (commercial name) produced by Du Pont). Other examples of the hydrogen ion conductor include such polymer materials as polystyrenesulfonic acid, sulfonated polyvinyl alcohol, etc., and fullerene derivatives.

Now, the membrane-electrode assembly (MEA) in this embodiment will be described in detail below referring to FIG. 3B.

In the oxygen electrode 1, an oxygen reduction catalyst layer 1a comprised of a mixture of the oxygen reduction catalyst comprised of the nitrogen-containing active carbide according to the present invention and the hydrogen ion conductor such as Nafion(R) is formed on a surface of a conductive porous support 1b such as carbon sheet and carbon cloth.

In the fuel electrode 3, like in the related art, a hydrogen oxidation catalyst layer 3a comprised of a mixture of a catalytically active metal such as platinum and platinum alloy with a hydrogen ion conductor such as Nafion(R) is formed on a surface of a conductive porous support 3b such as carbon sheet and carbon cloth.

Thus, the layer comprised of a material excellent in chemical stability, for example, a layer of a perfluorosulfonic acid resin such as Nafion(R) is disposed as both surface layers of the membrane exposed directly to the electrode reaction, and, moreover, the layer comprised of the same material is formed also on the electrode side to thereby form the membrane-electrode assembly (MEA), whereby a good joint surface which is chemically stable and through which hydrogen ions and electrons can move smoothly is formed.

### EXAMPLES OF FIRST EMBODIMENT

Now, preferred examples according to the first embodiment of the present invention will be described in detail below.

In the following, examples in which a nitrogen-containing active carbide catalyst is synthesized by using coal-derived binder pitch as the carbonaceous solid raw material and using melamine as the nitrogen-containing organic compound, and a fuel cell is produced by use of the catalyst, will be described.

<Synthesis of Nitrogen-containing Active Carbide Catalyst, and Production of Oxygen Electrode and MEA>

### Example 1

Coal-derived binder pitch and melamine were weighed in a mass ratio of 95:5, and ground and mixed in a mortar to obtain 4 g of a powder, which was put in the specimen tube 21, and the specimen tube 21 was set in the above-mentioned synthesizing apparatus. Baking was conducted in a high-purity nitrogen gas stream by raising temperature from normal temperature to 1000° C. at a temperature rising rate of 5° C./min, and the temperature was then maintained at 1000° C. for 1 hr. During the period of 1 hr, steam activation was also conducted. The dropping rate of water was 0.5 ml/hr, and the amount of water used was 0.5 ml. Thereafter, the temperature was let lower to room temperature. The baking changed the powdery specimen to a nitrogen-containing carbide powder, which was changed by the steam activation to a nitrogen-containing active carbide. After the treatment, the mass of the binder pitch was found reduced to about one half of the original, whereas the melamine component was little left. In this example, about 2 g (1.975 g) of the nitrogen-containing active carbide was obtained.

The nitrogen-containing active carbide was mixed with a Nafion(R) solution used as a hydrogen ion conductor, to obtain a slurry-like mixture in ethanol as solvent in which the mass ratio of the nitrogen-containing active carbide to the solid component of the Nafion(R) solution was 8:2. The slurry-like mixture was applied to a carbon sheet, the solvent was evaporated off, and the carbon sheet was punched into a disk-like shape having a diameter of 15 mm, to produce an oxygen electrode.

On the other hand, a commercially available carbon sheet coated with a platinum-carrying carbon catalyst was punched into a disk-like shape having a diameter of 10 mm, to produce a fuel electrode. Further, Nafion(R) 112 punched into a disk-like shape with a diameter of 15 mm was sandwiched between the two electrodes, followed by heat fusing at 150° C., to produce a membrane-electrode assembly (MEA)

### Example 2

The same procedure as in Example 1 was conducted, except that the coal-derived binder pitch and melamine were weight in a mass ratio of 75:25.

### Example 3

The same procedure as in Example 1 was conducted, except that the coal-derived binder pitch and melamine were weighed in a mass ratio of 50:50.

### Example 4

The same procedure as in Example 1 was conducted, except that the coal-derived binder pitch and melamine were weighed in a mass ratio of 25:75.

### Example 5

The same procedure as in Example 1 was conducted, except that the coal-derived binder pitch and melamine were weighed in a mass ratio of 5:95. After the treatment, the mass of the binder pitch was found reduced to about one half of the original, whereas the melamine component was little left, and only 0.077 g of the nitrogen-containing active carbide was obtained in this example.

### Example 6

The same procedure as in Example 1 was conducted, except that the melamine was not mixed with the binder pitch and only the binder pitch was baked to prepare the nitrogen-containing carbide powder.

### Example 7

The same procedure as in Example 1 was conducted, except that a graphite powder was used in place of the nitrogen-containing carbide powder prepared from the coal-derived binder pitch and melamine through baking.

### Example 8

The same procedure as in Example 1 was conducted, except that acetylene black was used in place of the nitrogen-containing carbide powder prepared from the coal-derived binder pitch and melamine through baking.

<Elemental Composition of the Carbide Surface>

Table 1 shows the results of determination of the elemental compositions of the surfaces of the nitrogen-containing active carbides obtained in Examples 1 to 5 and the carbides produced in Examples 6 to 8 by XPS (X-ray Photoelectron Spectroscopy) measurement. In all the case of the carbon materials, the elements detected were only carbon, oxygen, and nitrogen, and other elements such as metals were not contained at all. Incidentally, the elemental compositions are given in atom number percentage. Besides, the ratio of shake-up carbon was determined in terms of the ratio of the spectrum having a peak at 291.8±0.5 eV based on the whole part of the spectrum of carbon C1s electron, and this can be deemed as the presence ratio of the shake-up carbon based on the total carbon (here and hereinafter).

TABLE 1

| | | | | Shake-up |
|---|---|---|---|---|
| | SurfaceElementalComposition (mol %) | | | Carbon |
| | Carbon | Oxygen | Nitrogen | (mol %) |
| Example1 | 94.53 | 4.51 | 0.96 | 8.62 |
| Example2 | 93.97 | 4.8 | 1.23 | 9.79 |
| Example3 | 94.94 | 3.28 | 1.77 | 11.18 |
| Example4 | 95.66 | 2.3 | 2.04 | 11.57 |
| Example5 | 94.35 | 3.47 | 2.19 | 11.41 |
| Example6 | 93.38 | 5.77 | 0.86 | 8.75 |
| Example7 | 97.6 | 2.4 | 0 | 10.60 |
| Example8 | 97.2 | 2.8 | 0 | 6.90 |

Comparing Examples 1 to 5, it is seen that, as the ratio of melamine based on the raw material for synthesizing the nitrogen-containing active carbide had been set higher, the presence ratio of nitrogen was higher, and the ratio of the shake-up carbon was also higher.

Also in the carbide synthesized from only the coal-derived binder pitch without addition of melamine in Example 6, 0.86 mol % of nitrogen was contained. This is the nitrogen which had been contained in the coal-derived binder pitch itself. On the other hand, graphite and acetylene black used as carbon raw material in Examples 7 and 8 had not contained nitrogen, and, as a result, nitrogen was not detected in the carbon materials after the steam activation treatment in these examples.

Incidentally, although graphite and acetylene black had not contained oxygen either, the carbon materials obtained in Examples 7 and 8 contained 2-3 mol % of oxygen. It is considered that this oxygen was introduced by the steam activation treatment.

<Bond State of Nitrogen>

It was found from the analysis of XPS spectra that the nitrogen atoms present in the vicinity of the surface included three kinds of nitrogen atoms N1 to N3 different in N1s electron bond energy. Table 2 shows the presence ratio (mol %) in terms of atom number percentage of N1 to N3 in the vicinity of the surface, obtained from the analysis of XPS spectra.

TABLE 2

| | N1 (mol %) | N2 (mol %) | N3 (mol %) |
|---|---|---|---|
| Example1 | 0.22 | 0.53 | 0.21 |
| Example2 | 0.25 | 0.78 | 0.20 |
| Example3 | 0.40 | 1.02 | 0.35 |
| Example4 | 0.48 | 1.28 | 0.28 |
| Example5 | 0.50 | 1.36 | 0.33 |
| Example6 | 0.19 | 0.47 | 0.19 |
| Example7 | 0 | 0 | 0 |
| Example8 | 0 | 0 | 0 |

The differences in the N1s electron bond energy reflect the differences in the bond state of the nitrogen atoms. The assignment of the nitrogen atoms N1 to N3 was conducted referring to the data given in Energy & Fuels, No. 12 (1998), pp. 672-681, or Carbon, No. 40, pp. 597-608. The first nitrogen atoms N1 are nitrogen atoms having an N1s electron bond energy of 398.5±0.5 eV, corresponding to pyridine type nitrogen. The second nitrogen atoms N2 are nitrogen atoms having an N1s electron bond energy of 401±0.5 eV, which are quaternary nitrogen, and are said to be hydrogenated pyridine type nitrogen or nitrogen in graphene layer. The third nitrogen atoms N3 are nitrogen atoms having an N1s electron bond energy of 403.5±0.5 eV, corresponding to oxidized pyridine type nitrogen.

In the nitrogen-containing active carbides in Examples 1 to 5, all of the presence ratios of the nitrogen atoms N1 to N3 tend to increase with an increase in the mixing ratio of melamine.

<Fuel Cell Characteristics>

Each of the membrane-electrode assemblies (MEAs) produced in Examples 1 to 5 and Examples 6 to 8 and the like was incorporated in the fuel cell shown in FIG. 2, moistened hydrogen was supplied to the fuel electrode at a flow rate of 30 ml/min, whereas air was supplied to the oxygen electrode at a flow rate of 20 ml/min, and the characteristics as an oxygen electrode catalyst in the fuel cell were examined, for the nitrogen-containing active carbide catalysts obtained in Examples 1 to 5 and the carbides produced in Examples 6 to 8. Here, hydrogen was added in large excess relative to oxygen, and the quantity of oxygen supplied was also sufficiently in excess as compared with the output current obtained.

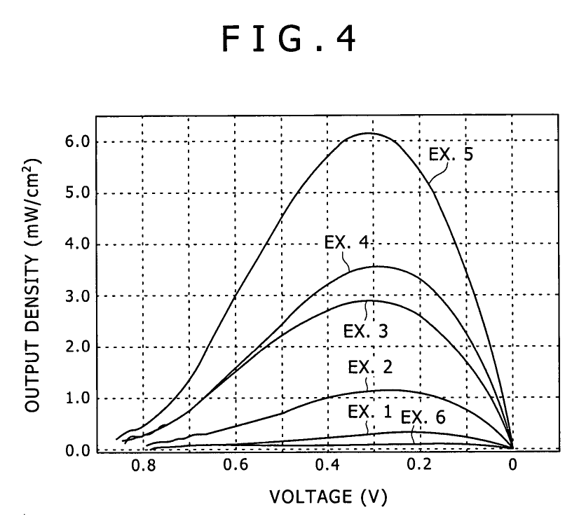

Table 3 shows the open circuit voltage measured in this experiment and the output density at the time of power generation at an output voltage of 0.4 V. In addition, FIG. 4 is a graph showing the relationship between the output voltage and the output density.

TABLE 3

| | Open circuit | Output density |
|---|---|---|
| | voltage(V) | (mW/cm²) |
| Example 1 | 0.80 | 0.22 |
| Example 2 | 0.80 | 0.96 |
| Example 3 | 0.84 | 2.70 |
| Example 4 | 0.85 | 3.15 |
| Example 5 | 0.86 | 5.71 |
| Example 6 | 0.75 | 0.06 |
| Example 7 | 0.32 | — |
| Example 8 | 0.63 | 0.02 |

The open circuit voltages shown by the carbon materials were all different. The open circuit voltage exceeded 0.8 V in all of Examples 1 to 5 in which the presence ratio of nitrogen was enhanced by mixing melamine, and the open circuit voltage increased as the amount of melamine mixed was further increased. In Examples 1 to 5, the output density also increased with an increase in the amount of melamine mixed. These tendencies correspond to the increase in the presence ratio of nitrogen and the increase in the presence ratio of shake-up carbon in Examples 1 to 5 shown in Table 1 above.

On the other hand, in the fuel cell using a nitrogen-containing active carbide with a low nitrogen presence ratio of 0.86% as in Example 6, the open circuit voltage was low, the output density was extremely low, and little power generation performance was obtained. In the fuel cells using a nitrogen-free carbide as the carbon material as in Examples 7 and 8, the open circuit voltage was low, little power generation performance was obtained, and it was found these carbon materials had little characteristics as an oxygen reduction catalyst.

Thus, it is evident that there is a correlation between the presence ratio of nitrogen and the presence ratio of shake-up carbon in the active carbide and the characteristics of the active carbon as an oxygen reduction catalyst, and it can be said to be important that the presence ratio of nitrogen in the surface of the active carbide is not less than 0.96%, for the active carbide to have the characteristics necessary to serve as an electrode catalyst for an oxygen electrode in a fuel cell.

In addition, in consideration of the results given in Table 2, for the active carbide to function as the oxygen electrode catalyst, it is indispensable that the presence ratio of nitrogen with each bond energy in the surface exceeds the value obtained in Example 1, and it is important that the presence ratio of nitrogen with a bond energy in the vicinity of 398.5±0.5 eV is not less than 0.22% (atom number percentage), that the presence ratio of nitrogen with a bond energy in the vicinity of 401±0.5 eV is not less than 0.53%, or that the presence ratio of nitrogen with a bond energy in the vicinity of 403.5±0.5 eV is not less than 0.21%.

<Measurement of Electron Spin Resonance (ESR)>

Carbon materials such as graphite contain carbon atoms having various bond structures, and a carbon atom in which the total number of electrons is an odd number is also present among them. Where a carbon atom has an odd number of electrons, an electron which is not paired but singly occupies an orbital, i.e., an unpaired electron is necessarily present. Since the unpaired electron has an electron spin of ½, the unpaired electron undergoes Zeeman splitting into two energy states different in the direction of electron spin when the carbon atom is placed in a magnetic field, showing the resonance absorption to an electromagnetic wave having a frequency ν which satisfies the following relational formula 1:
hν=gβH
where g is called g factor or gyromagnetic ratio, and is a value intrinsic of the substance having the unpaired electrons, h is the Plank's constant of 6.6255×10⁻³⁴ Js, β is a Bohr magnetron of 9.274×10⁻²⁴ JT⁻¹, and H is the intensity of the magnetic field expressed in unit T. The method of measuring the electron spin resonance (ESR) is a measuring method based on the above-mentioned principle, and is effective for examining the bond structure of a substance having the unpaired electrons.

Table 4 shows the results obtained when measurement of ESR spectrum was conducted for the nitrogen-containing active carbides obtained in Examples 1 to 5 and the carbides produced in Examples 6 and 7, and the spin density as the density of unpaired electrons was obtained from the absorption intensity. The nitrogen-containing active carbides of Examples 1 to 5 and the carbide of Example 6 has two kinds of unpaired electrons, i.e., unpaired electrons having a g value (determined from the ESR spectrum) of 1.99980-2.0000 and unpaired electrons having a g value of 2.0020-2.0026. On the other hand, the carbide of Example 7 which did not contain nitrogen had only one kind of unpaired electrons with a g value of 2.0075.

TABLE 4

| | g value | Spin density (pieces/g) |
|---|---|---|
| Example 1 | 2.0000 | 3.1 × 10¹⁹ |
| | 2.0025 | 6.0 × 10¹⁴ |
| Example 2 | 1.9980 | 2.5 × 10¹⁹ |
| | 2.0020 | 1.1 × 10¹⁵ |
| Example 3 | 1.9980 | 1.9 × 10¹⁹ |
| | 2.0023 | 1.5 × 10¹⁵ |
| Example 4 | 1.9980 | 9.5 × 10¹⁸ |
| | 2.0025 | 1.7 × 10¹⁵ |
| Example 5 | 2.0000 | 2.3 × 10¹⁸ |
| | 2.0026 | 2.0 × 10¹⁵ |
| Example 6 | 1.9980 | 3.5 × 10¹⁹ |
| | 2.0020 | 3.6 × 10¹⁴ |
| Example 7 | 2.0075 | 8.4 × 10¹⁸ |

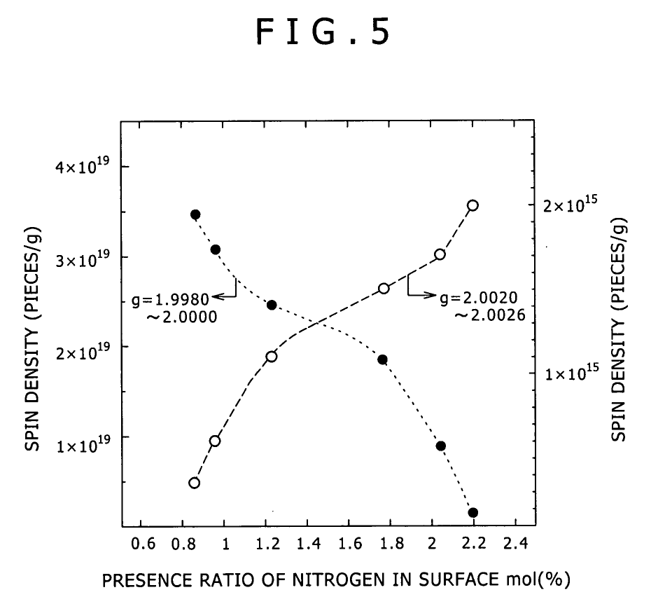

FIG. 5 is a graph showing the relationship between the spin densities of two kinds of unpaired electrons in the nitrogen-containing active carbides of Examples 1 to 5 and the carbide of Example 6 and the presence ratio of nitrogen in the surface shown in Table 1. According to FIG. 5, the spin density of the unpaired electrons with a g value of 1.9980-2.0000 decreases with an increase in the presence ratio of nitrogen, while the spin density of the unpaired electrons with a g value of 2.0020-2.0026 increases with an increase in the presence ratio of nitrogen, and a correlation is clearly recognized between the spin densities of the unpaired electrons and the presence ratio of nitrogen.

Unpaired electrons observed in ordinary carbon materials are unpaired electrons occupying the conduction band, are delocalized relative to the electronic structure of the molecule, and are uniformly distributed over the whole part of the molecule. These electrons show Pauli paramagnetism, and the magnetic susceptibility thereof is constant independently of temperature, up to a comparatively high temperature. The electron spins showing paramagnetism include not only this but also an electron spin according to Curie's law that the magnetic susceptibility is inversely proportional to absolute temperature, and the latter electron spin is called Curie paramagnetism spin. The Curie paramagnetism is due to the spins of localized electrons, i.e., the electrons having a presence probability distribution concentrated in a fixed location in the electronic structure of molecule. Whether the unpaired electron is Pauli paramagnetism or Curie magnetism can be easily judged by examining the temperature dependency of ESR absorption spectrum intensity.

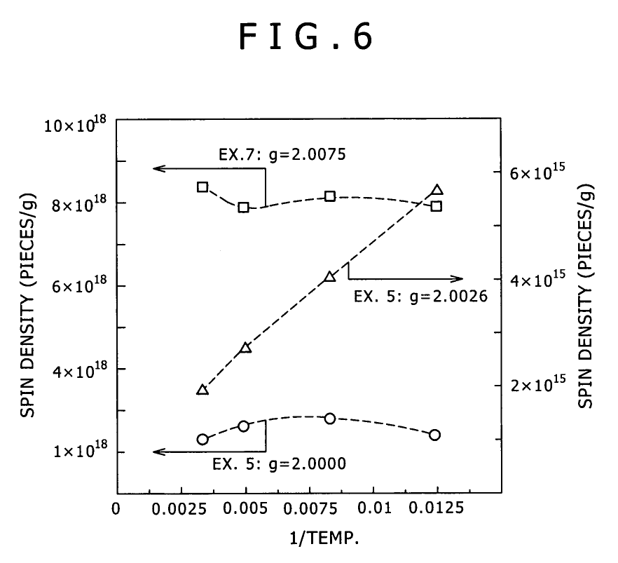

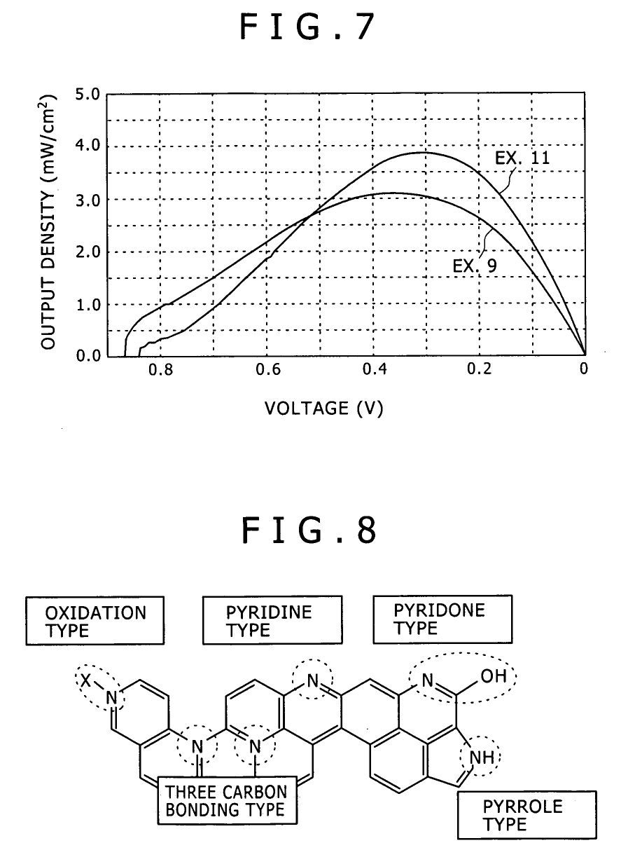

Table 5 and FIG. 6 show the results of examination of the temperature dependency of the spin densities of the two kinds of unpaired electrons contained in the nitrogen-containing active carbide of Example 5 and the unpaired electrons contained in the carbide of Example 7, by measuring the ESR absorption spectrum intensity at different temperatures. The measurement was conducted at four temperatures of 296 K, 200 K, 120 K, and 80 K.

TABLE 5

| | Spin density (pieces/g) | | |
|---|---|---|---|
| | Example 5 g | Example 5 g | Example 7 g |
| Temperature | value = | value = | value = |
| (K) | 2.0000 | 2.0026 | 2.0075 |
| 296 | 2.3 × 10¹⁸ | 2.0 × 10¹⁵ | 8.4 × 10¹⁸ |
| 200 | 2.6 × 10¹⁸ | 2.8 × 10¹⁵ | 7.9 × 10¹⁸ |
| 120 | 2.8 × 10¹⁸ | 4.1 × 10¹⁵ | 8.2 × 10¹⁸ |
| 80 | 2.4 × 10¹⁸ | 5.7 × 10¹⁵ | 7.9 × 10¹⁸ |

The spin densities of the unpaired electrons with a g value of 2.0000 contained in the nitrogen-containing active carbide of Example 5 and the unpaired electrons with a g value of 2.0075 contained in the carbide of Example 7 did not show dependence on temperature, which shows that these unpaired electrons are unpaired electrons showing Pauli paramagnetism recognized also in ordinary carbon materials.

On the other hand, the spin density of the unpaired electrons with a g value of 2.0026 contained in the nitrogen-containing active carbide of Example 5 showed an increase as the temperature is lowered, which show that the unpaired electrons are unpaired electrons showing Curie paramagnetism. As has been described above, the unpaired electrons showing Curie paramagnetism are localized relative to the electronic structure of molecule, and such unpaired electrons are peculiar electrons which are not observed in nitrogen-free ordinary carbon materials, as in the case of the carbide of Example 7.

FIG. 8 is a chemical formula showing the nitrogen species presumed to be present in a nitrogen-containing active carbide (Carbon, No. 40 (2002), pp. 597-608). By use of a molecular orbital method computation software “Spartan '04 for Windows”, single occupied molecular orbitals (SOMOs) of various nitrogen-containing graphite structures were computed. As a result, it was found that only the carbon materials having nitrogen having an electron configuration of sp² hybrid orbital connected with three carbon atoms (called also three-carbon bonding sp² nitrogen; or quaternary nitrogen or carbon substituted nitrogen) designated as “three-carbon bonding type” in the figure assume the structure in which unpaired electrons are localized. Therefore, it proved that the unpaired electrons showing Curie paramagnetism are special electrons which only the nitrogen-containing carbon materials having a particular bond structure, among the nitrogen-containing carbon materials, can have. It is considered that such localized unpaired electrons, which are not observed in other carbon materials than the nitrogen-containing active carbides, are playing an important role in catalytic activity.

Thus, it is considered that, since the unpaired electrons showing Curie paramagnetism were added to the carbon material containing the unpaired electrons showing Pauli paramagnetism while controlling the spin density thereof in the nitrogen-containing active carbon catalyst based on the present invention, a functional carbon material with good electronic conductivity and an oxygen reduction catalyst property was realized.

While the coal-derived binder pitch was used as a carbon source, melamine was used as a nitrogen source and a mixture of them was baked in Examples 1 to 5, the method for obtaining the effects of the present invention is not limited to the use of these materials. For example, as described in Energy & Fuels, No. 12 (1998), pp. 672-681, the presence ratio of nitrogen can be enhanced also by use of hydrazine in place of melamine as the nitrogen source. In addition, the baking may be conducted in an ammonia atmosphere. Besides, nitrogen-containing active carbides having the same catalytic activity as obtained in Examples 1 to 5 can be obtained also by using a nitrogen-containing synthetic polymer such as polyacrylonitrile, nylon, melamine resin, etc. or a nitrogen-containing natural organic polymer compound such as protein such as gelatin, collagen, etc. as a raw material. Now, examples in which acrylonitrile or a melamine resin is used as a raw material will be shown below.

### Example 9

The same procedure as in Example 1 was conducted, except that a polyacrylonitrile powder was baked in place of the powdery mixture of coal-derived binder pitch and melamine.

### Example 10

The same procedure as in Example 9 was conducted, except that the baking temperature was not 1000° C. but 600° C.

### Example 11

Melamine, commercially available formalin and water were mixed in a mass ratio of 1:2:2, and the mixture was boiled by heating under a weak basic condition of pH 9. Then, the deposited white solid matter (melamine resin) was recovered. The same procedure as in Example 1 was conducted, except that the powder of this resin was baked in place of the powdery mixture of the coal-derived binder pitch and melamine.

Table 6 shows the presence ratio of the first to third nitrogen atoms N1 to N3 and the presence ratio of shake-up carbon in the surfaces of the nitrogen-containing active carbides obtained in Examples 9 to 11, determined by XPS, in the same manner as for Table 2. It proved that all the nitrogen-containing active carbides contained the first to third nitrogen atoms N1 to N3 characterized by the above-mentioned N1s electron bond energy.

TABLE 6

| | | | | Shake-up | Output |
|---|---|---|---|---|---|
| | N1 | N2 | N3 | Carbon | Density |
| | (mol %) | (mol %) | (mol %) | (mol %) | (mW/cm²) |
| Example9 | 1.1 | 2.6 | 0.5 | 3.9 | 3.09 |
| Example10 | 5.4 | 5.6 | 1.3 | 1 | 0.23 |
| Example11 | 0.59 | 1.58 | 0.56 | 12.29 | 3.59 |

Moistened hydrogen was supplied to the fuel electrode at a flow rate of 30 ml/min, while air was supplied to the oxygen electrode at a flow rate of 20 ml/min. The relationships between output voltage and output density in Examples 9 and 11 are shown in FIG. 5. The power generation performances in Examples 9 and 11 were next to Example 5, and were on the same level as Example 4. The results of measurement of output density at the time of power generation at an output voltage of 0.4 V, for the fuel cells obtained in Examples 9 to 11, are shown in Table 4.

Comparing Example 9 in which polyacrylonitrile was baked at 1000° C. with Example 10 in which polyacrylonitrile was baked at 600° C., it is seen that in Example 10 in which the baking temperature is lower and the activation is insufficient, the presence ratio of shake-up carbon is lower, with the result that the catalytic performance is insufficient, and the output density of the fuel cell configured is lower.

In addition, comparing Example 9 with Example 11, it is seen that the presence ratio of nitrogen and the presence ratio of shake-up carbon can be varied by selection of the materials. It is also seen that in the case where polyacrylonitrile is baked, the presence ratio of nitrogen is high but the presence ratio of shake-up carbon is low, whereas in the case where the melamine resin is baked, the presence ratio of shake-up carbon is high but the presence ratio of nitrogen is low. As a result, it is seen that the output densities of the fuel cells obtained in both cases are roughly the same. In other words, it is seen that in order to enhance the catalytic performance and to enhance the output density of the fuel cell configured, it is necessary to enhance both the presence ratio of nitrogen and the presence ratio of shake-up carbon.

### Example 12

While the foregoing have been examples of application of the catalyst of the present invention to polymer electrolyte type fuel cells using a polymer membrane as electrolyte, the oxygen reduction catalyst according to the present invention is not only applicable to the polymer electrolyte type fuel cells but also applicable to phosphoric acid type fuel cells. Now, examples of the application to phosphoric acid type fuel cells will be described below.

A silicon carbide powder was kneaded with polytetrafluoroethylene in a mass ratio of 8:2, the kneaded matter was rolled to obtain a membrane-like formed body, and the formed body as a matrix was impregnated with phosphoric acid in vacuum, to obtain an electrolyte. On the other hand, the nitrogen-containing active carbide synthesized in Example 4 was kneaded with polytetrafluoroethylene in a mass ratio of 8:2, and the kneaded matter was rolled. The rolled product was dried, and then punched into a disk-like shape having a diameter of 15 mm, to produce an oxygen electrode.

On the other hand, a commercially available carbon sheet coated with a platinum-carrying carbon catalyst was punched into a disk-like shape having a diameter of 10 mm, to obtain a fuel electrode. Further, the electrolyte was sandwiched between the two electrodes, the resulting assembly was incorporated into a fuel cell shown in FIG. 2, in the same manner as in Example 1 and the like, moistened hydrogen was supplied to the fuel electrode at a flow rate of 30 ml/min, whereas air was supplied to the oxygen electrode at a flow rate of 20 ml/min, and power generation characteristics were evaluated.

The open circuit voltage and the output density at the time of power generation at an output voltage of 0.4 V are shown in Table 7.

TABLE 7

| | Open circuit | Output density |
|---|---|---|
| | Voltage (V) | (mW/cm²) |
| Example 12 | 0.86 | 2.37 |

Thus, the nitrogen-containing active carbon catalysts obtained in Examples 1 to 5, 9 and 11 of the present invention can be used as the catalyst for the oxygen electrode also in the phosphoric acid type fuel cell.

As has been described above, based on the experimental results, it was found out that when a material containing carbon and nitrogen as component elements is baked and the resulting baked matter is subjected to steam activation, it is possible to synthesize a nitrogen-containing active carbide in which both the presence ratio of nitrogen and the presence ratio of shake-up carbon in the surface thereof are controlled to be high, and the spin density of unpaired electrons showing Curie paramagnetism is controlled to be high, and that this material shows characteristics effective for use as an oxygen reduction catalyst; based on the findings, the present inventors have succeeded in applying this material to the oxygen electrode in a fuel cell. According to the present examples, it is possible to reduce the raw material cost of an oxygen electrode to an extremely low level, thereby contributing to a reduction in the cost of the fuel cells in which platinum has hitherto been used as an electrode catalyst for the oxygen electrode.

While the first embodiment and examples of the present invention have been described above, the present invention is not limited in any way to the embodiment and the examples, and naturally can be modified appropriately based on the technical thought of the invention.

The present invention is based on the experimental finding that the catalytic action of a nitrogen-containing active carbide have relation with the presence ratio of nitrogen in the surface thereof and with the above-mentioned shake-up process in XPS measurement, and is enhanced as the presence ratio of carbon giving a spectrum having a peak at 291.8±0.5 eV (hereinafter referred, as required, to as shake-up carbon) is higher, and as the spin density of the second unpaired electrons with a g value of 2.0020-2.0026 is higher.

The reason why the catalytic action of the nitrogen-containing active carbide is enhanced by the presence of the shake-up carbon is not yet elucidated, but, in consideration that the catalytic action is on the reaction attended by the transfer of electrons, it is considered that the reason has some relationship with the fact that the shake-up carbon has relation with the electronic conductivity of the carbon material.

In addition, as will be detailed in examples later, the second unpaired electrons with a g value of 2.0020-2.0026 are peculiar electrons not observed in nitrogen-free carbon materials, show Curie paramagnetism, and are unpaired electrons localized in a fixed location in the molecule. According to the molecular orbital method computation, it has proved that the unpaired electrons showing Curie paramagnetism are special electrons which can be possessed by only a material containing nitrogen having an electronic configuration of sp² hybrid orbital and connected to three carbon atoms, among nitrogen-containing carbon materials. It is considered that such localized unpaired electrons, not observed in other carbon materials than the nitrogen-containing active carbides, are playing an important role in catalytic activity.

According to the catalyst and the production method thereof according to the present invention, a material containing carbon and nitrogen as component elements is baked, and the resulting baked body is subjected to steam activation, whereby the presence ratio of carbon relating to the shake-up process and/or the spin density of the first unpaired electrons with a g value of 1.9980-2.0000 and the spin density of the second unpaired electrons with a g value of 2.0020-2.0026 are controlled. Therefore, it is possible to provide a catalyst and a production method thereof in which the catalytic action of the nitrogen-containing active carbide enhanced by the action of nitrogen is further enhanced.

In addition, the electrochemical-device according to the present invention includes the catalyst in which the presence ratio of carbon relating to the shake-up process and/or the spin density of the first unpaired electrons with a g value of 1.9980-2.0000 and the spin density of the second unpaired electrons with a g value of 2.0020-2.0026 are controlled. Therefore, in the electrochemical device, the transfer of electrons on the electrodes and in the like areas occurs rapidly, and there is little possibility of polarization or the like.

### Second Embodiment

In a second embodiment of the present invention, it is preferable that a conductive material is added to the nitrogen-containing carbonaceous catalyst for accelerating an oxygen-reducing reaction of the following formula:
O₂+4H⁺+4e⁻→2H₂O
and the hydrogen ion conductive polymer material, to produce the powdery mixture, and the powdery mixture is formed to produce the catalyst electrode. The conductivity of the catalyst electrode has been secured by the conductivity of the carbonaceous material, but it can be further enhanced by the addition of the conductive material.

Besides, it is preferable to use a perfluorosulfonic acid-based resin as the hydrogen ion conductive polymer material. The perfluorosulfonic acid-based resin is chemically stable, and is therefore preferable. In addition, in the case of applying the catalyst electrode to the oxygen electrode in a fuel cell or the like such as PEFC, a perfluorosulfonic acid-based resin membrane is ordinarily used as a polymer electrolyte membrane. Therefore, where the hydrogen ion conductive polymer material is set to be the same as the membrane material, there is obtained the merit that a good membrane-electrode joint surface can be formed.

In this case, the mixing ratio of the perfluorosulfonic acid-based resin is preferably in the range of 5 to 30 mass %, inclusive. If the amount of the perfluorosulfonic acid-based resin used in producing the electrode is too small, a three-phase interface with a sufficient area cannot be formed. On the other hand, if the amount is too large, the perfluorosulfonic acid-based resin would interrupt the oxygen flow path from the gaseous phase to the nitrogen-containing carbonaceous catalyst.

Besides, the pressure used in press forming is preferably in the range of 2.8 to 39.6 kN/cm², inclusive. If the pressure is too low, a sufficiently rigid formed body cannot be obtained, and, even if the rigid formed body can be obtained, the bonding between the component particles would be insufficient, the electric conductivity or hydrogen ion conductivity would be insufficient, or the different-phase interface on the nitrogen-containing carbonaceous catalyst cannot be formed appropriately. On the other hand, if the pressure is too high, the pores in the inside of the catalyst electrode would be pressed down, and flow paths for gases would be interrupted, which is undesirable.

In addition, as the nitrogen-containing carbonaceous catalyst, a nitrogen-containing active carbide catalyst according to the precedent application invention is preferably used. The present invention is applied most suitably to a catalyst which, like activated carbon, is porous and electrically conductive, but is not high in catalytic efficiency per unit volume.

In the case, for example, where the catalyst is provided on a surface of a support so as to cover the surface, in the case where the catalyst is used as a planar formed body such as the above-mentioned catalyst electrode and in the like cases, the mass of the nitrogen-containing carbonaceous catalyst per unit area (hereinafter abridged to surface density of catalyst) is preferably in the range of 10 to 110 mg/cm², inclusive. The reason is as follows. In a region where the surface density of the catalyst is low, when the amount of the nitrogen-containing carbonaceous catalyst per unit area is increased, the performance is enhanced accordingly. However, when the surface density is enlarged and the thickness of the catalyst or the catalyst layer in the catalyst electrode becomes too large, it becomes difficult for gases, ions and/or electrons to move in the inside of the catalyst or the catalyst electrode.

Besides, it is preferable that the catalyst electrode is used as an oxygen electrode, the hydrogen ion conductive membrane is clamped between the oxygen electrode and a hydrogen electrode to form a membrane-electrode assembly, and the assembly is used in an electrochemical reaction part of an electrochemical device. In addition, the electrochemical device is preferably configured as a cell, particularly a fuel cell. With the membrane-electrode assembly thus formed, the movement of hydrogen ions and electrons at the three-phase interface occurs smoothly, and polarization is restrained.

Now, a fuel cell in which a catalyst electrode using a nitrogen-containing active carbide catalyst based on the precedent application invention as the nitrogen-containing carbonaceous catalyst is used as an oxygen electrode and which is a preferable second embodiment of the present invention will be described in detail below, referring to the drawings.

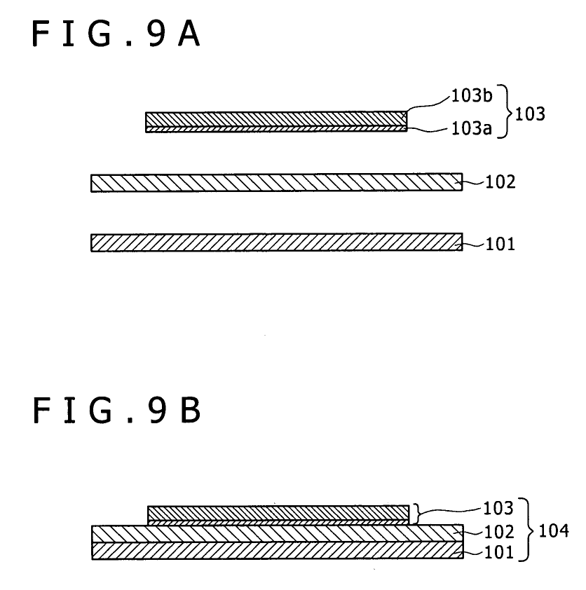

FIG. 9A is a general sectional view of electrodes and a hydrogen ion conductive membrane, showing the electrodes and the like constituting an electrochemical part in a fuel cell in this embodiment, and FIG. 9B is a general sectional view of a membrane-electrode assembly (MEA). A fuel electrode 103 and an oxygen electrode 101 are joined respectively to both sides of a hydrogen ion conductive polymer electrolyte membrane 2 having hydrogen ion conductivity, to form a membrane-electrode assembly (MEA) 104.

The oxygen electrode 101 is a catalyst electrode based on the present invention, in which a catalyst layer functions also as an electrode. Though not shown in FIG. 9B, a metallic electrode may be adhered to and electrically connected to the catalyst electrode 101, for lowering the electrode resistance.

To be more specific, a formed body obtained by forming a powdery mixture of the nitrogen-containing active carbide catalyst and a hydrogen ion conductive polymer material such as Nafion(R) into a disk-like shape under pressure or the like can be used as the catalyst electrode 101. In the press forming, heating may be used together.

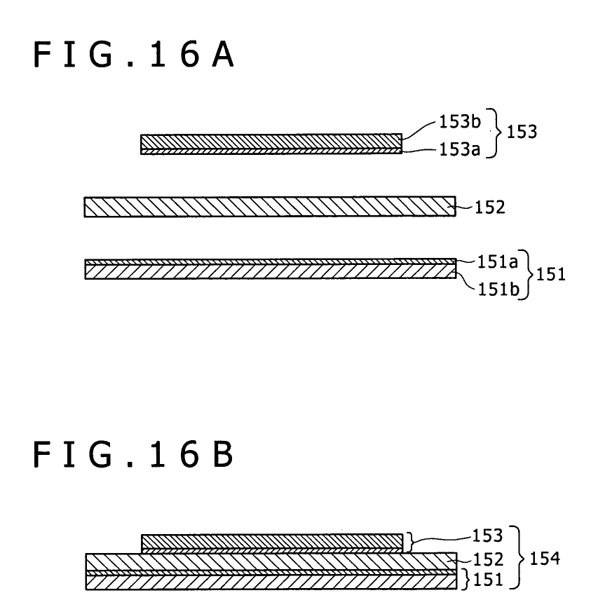

On a material basis, the catalyst electrode 101 is essentially the same as the catalyst layer formed by the conventional applying (coating) method, as has been described referring to FIGS. 16A and 16B. However, the press forming makes it possible to produce the catalyst layer in an arbitrary thickness. By enlarging the thickness of the catalyst electrode 101 so as to increase the amount of the catalyst per unit area, it is possible to permit even a low-efficiency catalyst such as the nitrogen-containing active carbon catalyst to display a sufficient catalytic performance.

In addition, since the catalyst electrode 101 has a stand-alone shape, it is unnecessary to provide a support for the catalyst layer or an electrode serving simply as a collector, as shown in FIGS. 9A and 9B. This is one of the merits of the catalyst electrode based on the present invention.

Another merit of forming the catalyst electrode resides in that since the catalyst electrode is formed by press forming, once a mold is prepared, even a catalyst electrode having a somewhat complicated shape on a three-dimensional basis such as a curved surface can be mass produced inexpensively and efficiently. For example, it is easy to produce a hollow cylindrical catalyst electrode for enhancing spatial efficiency.

In addition, catalyst electrodes produced separately may be used in a laminated state. For example, a plurality of catalyst electrodes set to be different in the ratio of pores constituting internal gas passages (porosity) by changing the forming pressure may be laminated on each other, so as thereby to control the flow of gas.

Besides, in order to assist the flow of gases and the flow of electrons in the inside of the catalyst electrode, a pipe of a porous material may be embedded in the catalyst electrode, or a meshed conductive material may be embedded in the catalyst electrode.

The fuel electrode 103 is the same as the hydrogen electrode in the related art, and has a configuration in which a hydrogen oxide catalyst layer 103a composed of a mixture of a catalytically active metal such as platinum, platinum alloy, etc. with a hydrogen ion conductive polymer material such as Nafion(R) is formed on a surface of a conductive porous substrate 103b such as carbon sheet, carbon cloth, etc. The fuel electrode 103 may be composed of a catalyst electrode containing an appropriate hydrogen oxidation catalyst.

The fuel electrode 103 and the oxygen electrode 101 are joined to each other, with a hydrogen ion conductive polymer electrolyte membrane 102 such as Nafion(R) sandwiched therebetween, to form the membrane-electrode assembly (MEA) 104, which is used as an electrochemical part of a fuel cell. As shown in FIG. 9B, a catalyst layer containing a hydrogen ion conductive polymer material which is the same as the material of the electrolyte membrane 102 is formed on an electrode surface of the fuel cell 103 to be joined to the hydrogen ion conductive polymer electrolyte membrane 102. The oxygen electrode 101 also is formed using the hydrogen ion conductive polymer material as a binder. Therefore, good joint surfaces through which hydrogen ions and electrons can move smoothly is formed.

In addition, when a perfluorosulfonic acid-based resin or the like such as Nafion(R) is used as the hydrogen ion conductive polymer material, both the surface layers of the membrane which are exposed directly to the electrode reaction are composed of a material high in chemical stability, so that an electrochemical device with excellent durability can be obtained.

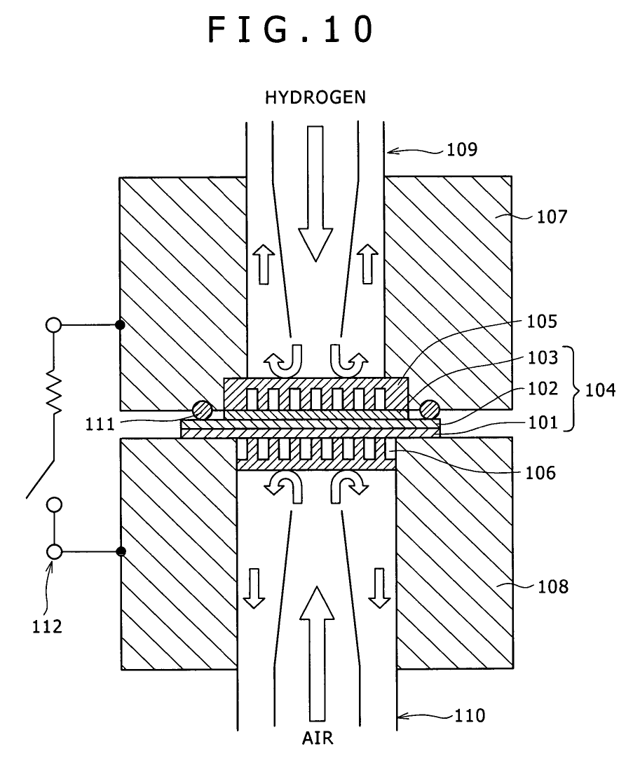

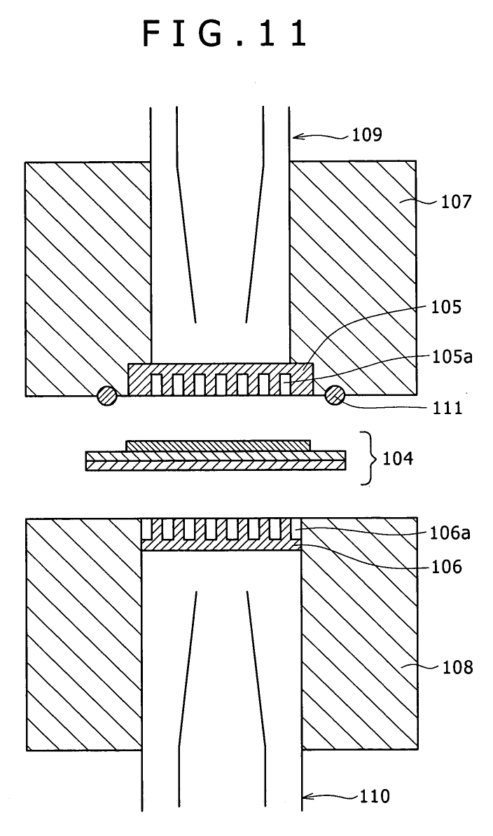

FIG. 10 is a general sectional view showing the configuration of a fuel cell. FIG. 11 is a general sectional view of the apparatus of FIG. 10 which is partly disassembled so that the configuration of the fuel cell is easy to look at. The membrane-electrode assembly (MEA) 104 is clamped between a cell upper half 107 and a cell lower half 108, thereby being incorporated in the fuel cell system. The cell upper half 107 and the cell lower half 108 are provided respectively with gas supply pipes 109 and 110. Hydrogen is fed through the gas supply pipe 109, while air or oxygen is fed through the gas supply pipe 110. The gases are supplied to the fuel electrode 103 and the oxygen electrode 101 through gas supply parts 105 and 106 having vent holes which are omitted in the figure. The gas supply part 105 provides electrical connection between the fuel electrode 103 and the cell upper half 107, while the gas supply part 106 provides electrical connection between the oxygen electrode 101 and the cell lower half 108. In addition, an O ring 111 for preventing leakage of hydrogen gas is attached to the cell upper half 107.

Power generation can be conducted by closing an external circuit 112 connected to the cell upper half 107 and the cell lower half 108 while supplying the above-mentioned gases. In this instance, hydrogen is oxidized by the reaction of the following formula (3):
2H₂→4H⁺+4e⁻ (3)
on the surface of the fuel electrode 103, to give electrons to the fuel cell 103. The resulting hydrogen ions H⁺ migrate through the hydrogen ion conductive membrane to the oxygen electrode 101. Here, the fuel electrode 103 may be supplied with methanol as a fuel in the case of the so-called direct methanol system.

The hydrogen ions reaching the oxygen electrode 101 react with oxygen supplied to the oxygen electrode 101 according to the following formula (4):
O₂+4H⁺+4e⁻→2H₂O (4)
to produce water. In this instance, oxygen picks up electrons from the oxygen electrode 101, thereby being reduced.

As the polymer electrolyte membrane 102, any of those having hydrogen ion conductivity can be used. Specific examples of the material which can be used for the polymer electrolyte membrane 102 include, first, hydrogen ion conductive polymer materials such as perfluorosulfonic acid-based resin, and other examples of the hydrogen ion conductor include such polymeric materials as polystyrenesulfonic acid, sulfonated polyvinyl alcohol, etc. and fullerene derivatives.

<Synthesis of Nitrogen-Containing Active Carbide Catalyst>

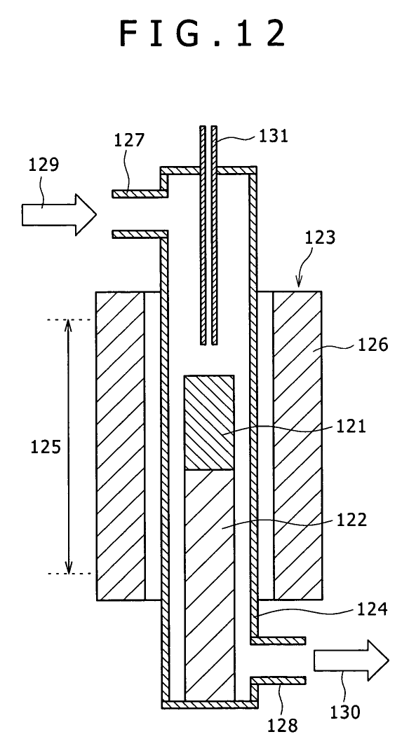

FIG. 12 is a general sectional view of an apparatus for synthesizing the nitrogen-containing active carbide catalyst based on a preferred embodiment of the present invention. A specimen is put in a specimen tube 121, which is placed on a specimen support base 122, the whole part of them is disposed in the inside of a core tube 124 of an electric furnace 123, and the position of the whole part is regulated so that the specimen is surrounded by a heating temperature zone 125 in the electric furnace 123. The electric furnace 123 is so configured that the gases in the inside of the core tube 124 are heated by passing an electric current to a heater part 126, and the specimen can be heated to a desired temperature through the gases. A gas inlet port 127 is provided at an upper portion of the core tube 124, while a gas discharge port 128 is provided at a lower portion of the core tube 124.

In baking the specimen, a high-purity nitrogen gas 129 is introduced through the gas inlet port 127, and the exhaust gas 130 upon reaction is discharged through the gas discharge port 128. The specimen tube 121 is so configured that the nitrogen gas 129 heated to a high temperature flows by or through the specimen, so that the specimen is carbonized by heating in an oxygen-free high-purity nitrogen gas atmosphere, to be changed into a carbide.

A water inlet pipe 131 is provided on the upper side of the specimen tube 121, and, at the time of steam activation, water is supplied into the inside of the core tube 124 through the water inlet pipe 131. The water thus supplied is evaporated in the vicinity of the outlet of the water inlet pipe 131, is carried by the high-purity nitrogen gas stream to the place of the specimen put in the specimen tube 121, and reacts here with the carbide through a hydrothermal reaction, for example, the reaction of the following formula:
C+H₂O→CO+H₂.
As a result, the carbide turns to be porous, whereby the surface area thereof is conspicuously increased, so that gas adsorption performance and catalytic action are activated remarkably.

### EXAMPLES OF SECOND EMBODIMENT

Now, preferred examples of the second embodiment of the present invention will be described specifically and in detail below.

First, description will be made of an example in which a nitrogen-containing active carbide catalyst was synthesized by using coal-derived binder pitch as a carbonaceous solid raw material and melamine as a nitrogen-containing organic compound, a catalyst electrode was produced by using the nitrogen-containing active carbide catalyst as a nitrogen-containing carbonaceous catalyst, and a fuel cell was produced by using the catalyst electrode as an oxygen electrode.

<Synthesis of Nitrogen-Containing Active Carbide>

In this example, a nitrogen-containing active carbide was synthesized by use of the synthesizing apparatus shown in FIG. 12. Coal-derived binder pitch and melamine were weighed in a mass ratio of 95:5, they were ground and mixed by use of a mortar, 4 g of the resulting powdery mixture was put in a specimen tube 21, and the specimen tube 21 was set in the synthesizing apparatus. Baking was conducted in a high-purity nitrogen stream, with temperature raised from normal temperature to 1000° C. at a temperature rising rate of 5° C./min, and the temperature was maintained at 1000° C. for one hour. During the period of one hour, steam activation was also conducted. The dropping rate of water was 0.5 ml/hr, and the amount of water used was 0.5 ml. Thereafter, the temperature was let lower to room temperature. The baking converted the powdery specimen into a nitrogen-containing carbide powder, which was changed into a nitrogen-containing active carbide by the steam activation. After the treatment, the mass of the binder pitch was reduced to about one half of the original, and the melamine component was little left. In this example, about 2 g (1.975 g) of the nitrogen-containing active carbide was obtained.

Incidentally, while the synthesis of the active carbon catalyst was conducted by baking the mixture of the coal-derived binder pitch as a carbon source and melamine as a nitrogen source, the raw materials for obtaining the nitrogen-containing active carbide are not limited to these materials. For example, nitrogen can be introduced into the active carbide by using hydrazine in place of melamine or by baking in an ammonium atmosphere. Further, also when the baking is conducted by using a nitrogen-containing polymer such as polyacrylonitrile, nylon, melamine resin, etc. or a protein such as galatin, collagen, etc. as a raw material, a nitrogen-containing active carbide having the same catalytic activity as above can be obtained.

For example, the precedent application invention describes the following Examples 1 to 6 in which a nitrogen-containing active carbide catalyst is synthesized in the same manner as in Example 1.

### Example 1

The same procedure as in Example 1 was conducted, except that the coal-derived binder pitch and melamine were weighed in a mass ratio of 75:25.

### Example 2

The same procedure as in Example 1 was conducted, except that the coal-derived binder pitch and melamine were weighed in the mass ratio of 50:50.

### Example 3

The same procedure as in Example 1 was conducted, except that the coal-derived binder pitch and melamine were weighed in the mass ratio of 25:75.

### Example 4

The same procedure as in Example 1 was conducted, except that the coal-derived binder pitch and melamine were weighed in the mass ratio of 5:95. Upon the treatment, the mass of the binder pitch was found reduced to about one half of the original, whereas the melamine component was little left, and only 0.077 g of the nitrogen-containing active carbide was obtained in this Example.

### Example 5

The same procedure as in Example 1 was conducted, except that a powder of polyacrylonitrile was baked in place of the powdery mixture of the coal-derived binder pitch and melamine.

### Example 6

Melamine, commercially available formalin and water were mixed in a mass ratio of 1:2:2, and the mixture was boiled by heating under a weak basic condition of pH 9. Thereafter, the deposited white solid matter (melamine resin) was recovered. The same procedure as in Example 1 was conducted, except that a powder of the resin thus obtained was baked in place of the powdery mixture of the coal-derived binder pitch and melamine.

Incidentally, comparing Example 1 with Examples 1 to 4, there is seen a tendency that the presence ratio of nitrogen is higher and the catalytic performance is enhanced as the ratio of melamine as a raw material for synthesizing the nitrogen-containing active carbide is raised.

<Production of Oxygen Electrode and MEA>

The above-mentioned nitrogen-containing active carbide catalyst and an ethanol solution of Nafion(R) 112, which is a perfluorosulfonic acid-based resin having hydrogen ion conductivity, were mixed in such amounts that the mass ratio of solid components was 80:20, then the solvent was evaporated off, and the resulting solid matter was ground in a mortar, to obtain a powder. Then, 10.0 mg of this powder was put in a dice having an inside diameter of 15 mm, and press forming was conducted at a pressure of 22.6 kN/cm², to produce a formed disk, which was used as an oxygen electrode.

On the other hand, a commercially available carbon sheet coated with a platinum-carrying carbon catalyst was punched into a disk-like shape with a diameter of 10 mm, to produce a fuel electrode. Further, Nafion(R) punched into a disk-like shape with a diameter of 15 mm was sandwiched between the two electrodes, and the members were heat fused at 150° C., to produce a membrane-electrode assembly (MEA).

Incidentally, the perfluorosulfonic acid-based resin is not limited to Nafion(R), and such perfluorosulfonic acid-based resins as Flemion(R) produced by Asahi Glass Co., Ltd. and Aciplex(r) produced by Asahi Kasei Co., Ltd. can also be applied.

### Example 2

The same procedure as in Example 1 was conducted, except that 22.1 mg of a powdery mixture of the nitrogen-containing active carbide catalyst and Nafion(R) was used in producing the formed disk electrode.

### Example 3

The same procedure as in Example 1 was conducted, except that 33.2 mg of a powdery mixture of the nitrogen-containing active carbide catalyst and Nafion(R) was used in producing the formed disk electrode.

### Example 4

The same procedure as in Example 1 was conducted, except that 44.3 mg of a powdery mixture of the nitrogen-containing active carbide catalyst and Nafion(R) was used in producing the formed disk electrode.

### Example 5

The same procedure as in Example 1 was conducted, except that 88.4 mg of a powdery mixture of the nitrogen-containing active carbide catalyst and Nafion(R) was used in producing the formed disk electrode.

### Example 6

The same procedure as in Example 1 was conducted, except that 110.4 mg of a powdery mixture of the nitrogen-containing active carbide catalyst and Nafion(R) was used in producing the formed disk electrode.

### Example 7

The same procedure as in Example 1 was conducted, except that 132.5 mg of a powdery mixture of the nitrogen-containing active carbide catalyst and Nafion(R) was used in producing the formed disk electrode.

### Example 8

The same procedure as in Example 1 was conducted, except that 176.7 mg of a powdery mixture of the nitrogen-containing active carbide catalyst and Nafion(R) was used in producing the formed disk electrode.

### Example 9

The same procedure as in Example 1 was conducted, except that 220.9 mg of a powdery mixture of the nitrogen-containing active carbide catalyst and Nafion(R) was used in producing the formed disk electrode.

### Example 10

The same procedure as in Example 1 was conducted, except that 243.0 mg of a powdery mixture of the nitrogen-containing active carbide catalyst and Nafion(R) was used in producing the formed disk electrode.

### Example 11

The same procedure as in Example 1 was conducted, except that 254.0 mg of a powdery mixture of the nitrogen-containing active carbide catalyst and Nafion(R) was used in producing the formed disk electrode.

### Comparative Example 1

The nitrogen-containing active carbide catalyst and an ethanol solution of Nafion(R) 112 which is a perfluorosulfonic acid-based resin having hydrogen ion conductivity were mixed in such amounts that the mass ratio between the solid components of the carbide catalyst and Nafion(R) 112 was about 80:20, then ethanol was further added to the mixture, to obtain a slurry, and the slurry was applied to a carbon sheet. After drying, pressing under a pressure of 0.5 kN/cm² was conducted, and the sheet was punched into a disk-like shape with a diameter of 15 mm, to produce an oxygen electrode.

### Comparative Example 2

The same procedure as in Comparative Example 1 was conducted, except that the step of applying the slurry of the catalyst was further repeated twice in the process of Comparative Example 1.

The surface densities of the active carbide catalyst in the oxygen electrodes produced in Examples 1 to 11 and Comparative Examples 1 and 2 are shown in Table 8.

TABLE 8

| | Surface density of active | Output density |
|---|---|---|
| | Carbide catalyst (mg/cm²) | (mW/cm²) |
| Example 1 | 5 | 1.3 |
| Example 2 | 10 | 2.2 |
| Example 3 | 15 | 2.8 |
| Example 4 | 20 | 4.6 |
| Example 5 | 40 | 7.3 |
| Example 6 | 50 | 12.5 |
| Example 7 | 60 | 18.2 |
| Example 8 | 80 | 22.8 |
| Example 9 | 100 | 25.0 |
| Example 10 | 110 | 24.5 |
| Example 11 | 115 | 20.5 |
| Comparative | 2 | 0.5 |
| Example 1 | | |
| Comparative | 6 | 1.7 |
| Example 2 | | |

In the methods in which the application (coating) was repeated, as in Comparative Examples 1 and 2, the number of times of coating had a limit of three. When it was tried to repeat the coating further, exfoliation of the coating layer became conspicuous, so that it was difficult to further enhance the surface density of the nitrogen-containing active carbide catalyst by the coating.

On the other hand, in Examples 1 to 11, formability (moldability) is good, so that it is possible to produce an electrode having an arbitrary catalyst surface density. The formed body is tough, and therefore has a characteristic feature that the electrode can be produced without using an electrode support such as carbon sheet.

<Fuel Cell Characteristic 1> <Variation with Surface Density of Catalyst>

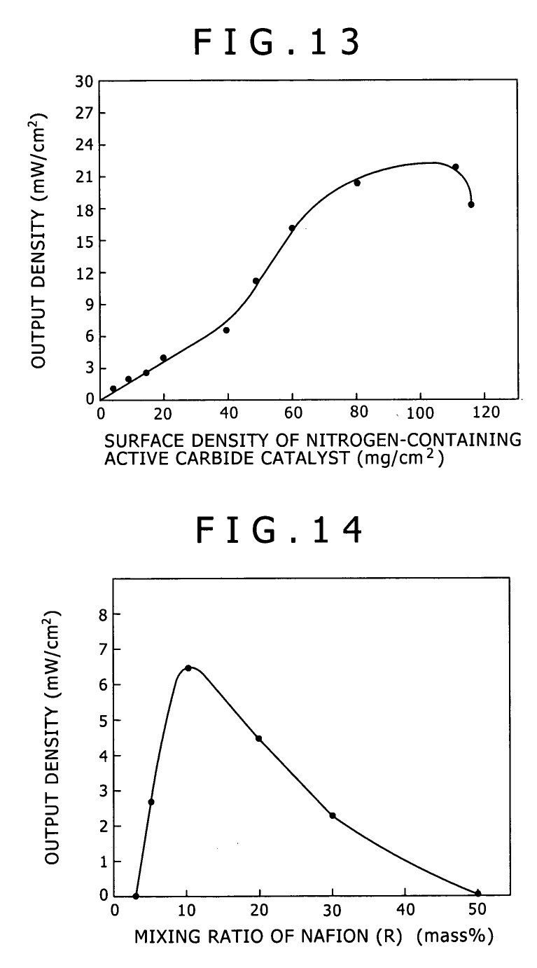

Each of the membrane-electrode assemblies (MEAs) produced in Examples 1 to 11 and Comparative Examples 1 and 2 was incorporated in a fuel cell shown in FIG. 10, moistened hydrogen was supplied to the fuel electrode at a flow rate of 30 ml/min, while air was supplied to the oxygen electrode at a flow rate of 20 ml/min, and the characteristics of the oxygen electrode in the fuel cell were examined. Here, hydrogen was added in large excess as compared with oxygen, and the amount of oxygen supplied was also sufficiently in excess as compared with the output current obtained. Table 8 and FIG. 13 show the output densities at the time of power generation by these fuel cells at an output voltage of 0.4 V (this applies hereinafter).

As shown in Table 8 and FIG. 13, in Examples 1 to 9, the output density of the fuel cell was enhanced with an increase in the surface density of the catalyst. On the other hand, in Example 10 and the latter examples, a reduction in output was observed. The reason for this seems to be as follows. The increase in the surface density of the catalyst leads to an increase in the reaction rate at the oxygen electrode, but the increase in the electrode thickness or the like leads to an increase in the internal resistance of the fuel system, and the increase in the internal resistance predominates the increase in the reaction rate.

Even the applying (coating) method according to the related art shown in Comparative Examples 1 and 2 can realize a loading density of up to 6 mg/cm². Therefore, the press formed disk electrodes in the present examples have a performance as an oxygen electrode in a fuel cell when having any of the catalyst densities. However, for sufficiently displaying the effects of the present invention, the surface density of the catalyst is preferably in the range of 10 to 110 mg/cm², inclusive, on a practical use basis.

<Fuel Cell Characteristic 2> <Mixing Ratio of Perfluorosulfonic Acid-Based Resin>

Next, the appropriate range of the mixing ratio of the perfluorosulfonic acid-based resin was investigated.

For the reaction at the oxygen electrode to take place, a site where adsorption of oxygen, conduction of hydrogen ions, and conduction of electrons are all possible is needed, as is clear from the above-mentioned formula (4). This site is called three-phase interface, and is formed at the interface between the air phase, the perfluorosulfonic acid-based resin which is the hydrogen ion conductor, and the electrode (catalyst).

If the amount of the perfluorosulfonic acid-based resin used in producing the electrode is too small, a three-phase interface with a sufficient area cannot be formed. On the other hand, if the amount is too large, the perfluorosulfonic acid-based resin would interrupt the oxygen passage from the air phase to the catalyst. In each of the two cases, good power generation characteristics cannot be obtained. Therefore, it is very important for producing the electrode to maintain the amount of the perfluorosulfonic acid-based resin in a well-balanced appropriate range.

### Example 12

The same procedure as in Example 4 was conducted, except that the nitrogen-containing active carbide and the ethanol solution of Nafion(R) 112 were mixed in such amounts that the mass ratio between the solid components of them was 97:3.

### Example 13

The same procedure as in Example 4 was conducted, except that the nitrogen-containing active carbide and the ethanol solution of Nafion(R) 112 were mixed in such amounts that the mass ratio between the solid components of them was 95:5.

### Example 14

The same procedure as in Example 4 was conducted, except that the nitrogen-containing active carbide and the ethanol solution of Nafion(R) 112 were mixed in such amounts that the mass ratio between the solid components of them was 90:10.

### Example 15

The same procedure as in Example 4 was conducted, except that the nitrogen-containing active carbide and the ethanol solution of Nafion(R) 112 were mixed in such amounts that the mass ratio between the solid components of them was 90:10.

### Example 16

The same procedure as in Example 4 was conducted, except that the nitrogen-containing active carbide and the ethanol solution of Nafion(R) 112 were mixed in such amounts that the mass ratio between the solid components of them was 70:30.

### Example 17

The same procedure as in Example 4 was conducted, except that the nitrogen-containing active carbide and the ethanol solution of Nafion(R) 112 were mixed in such amounts that the mass ratio between the solid components of them was 50:50.

The electrodes produced in Examples 12 to 17 were examined for characteristics as a fuel cell oxygen electrode catalyst. The output power densities at the time of power generation at an output voltage of 0.4 V are shown in Table 9 and FIG. 14.

TABLE 9

| | Ratio of Nafion(R) | Output density |
|---|---|---|
| | (mass %) | (mW/cm²) |
| Example 12 | 3 | — |
| Example 13 | 5 | 2.7 |
| Example 14 | 10 | 6.5 |
| Example 15 | 20 | 4.6 |
| Example 16 | 30 | 2.4 |
| Example 17 | 50 | 0.1 |

In Example 12, in the case where the mixing ratio of Nafion(R) which is a perfluorosulfonic acid-based resin functioning also as a binder is below 3 mass %, the electrode would be broken at the time of production thereof due to its weak force of keeping the form thereof, and evaluation of performance was therefore impossible. As shown by the results in Table 10 and FIG. 14, the best output was obtained when the mixing ratio of Nafion(R) was 10 mass %; when the mixing ratio was more than 10 mass %, the output was rapidly reduced due to the interruption of oxygen passages, and little power generation characteristic was obtained when the mixing ratio of Nafion(R) was 50 mass %. Accordingly, for sufficiently displaying the intrinsic effects of the present invention, the mixing ratio of the perfluorosulfonic acid-based resin is desirably in the range of 5 to 30 mass %, inclusive.

<Fuel Cell Characteristic 3> <Influences of Pressure at the Time of Press Forming>

Next, the appropriate range of the pressure at the time of press forming was investigated.

In the production of a disk electrode by press forming, not only the mixing ratio of the perfluorosulfonic acid-based resin but also the pressure at the time of forming is important. The reason is as follows. If the pressure is too low, forming of the disk cannot be attained, and, even if the forming is attained, the mutual contact between the catalyst particles is weak, which would cause an increase in the contact resistance between the particles. On the other hand, if the pressure is too high, the oxygen passages would be interrupted, which is undesirable.

### Example 18

The same procedure as in Example 4 was conducted, except that the pressure applied at the time of producing the disk electrode was 1.4 kN/cm².

### Example 19

The same procedure as in Example 4 was conducted, except that the pressure applied at the time of producing the disk electrode was 2.8 kN/cm².

### Example 20

The same procedure as in Example 4 was conducted, except that the pressure applied at the time of producing the disk electrode was 5.6 kN/cm².

### Example 21

The same procedure as in Example 4 was conducted, except that the pressure applied at the time of producing the disk electrode was 11.3 kN/cm².

### Example 22

The same procedure as in Example 4 was conducted, except that the pressure applied at the time of producing the disk electrode was 17.0 kN/cm².

### Example 23

The same procedure as in Example 4 was conducted, except that the pressure applied at the time of producing the disk electrode was 22.6 kN/cm².

### Example 24

The same procedure as in Example 4 was conducted, except that the pressure applied at the time of producing the disk electrode was 28.2 kN/cm².

### Example 25

The same procedure as in Example 4 was conducted, except that the pressure applied at the time of producing the disk electrode was 34.0 kN/cm².

### Example 26

The same procedure as in Example 4 was conducted, except that the pressure applied at the time of producing the disk electrode was 39.6 kN/cm².

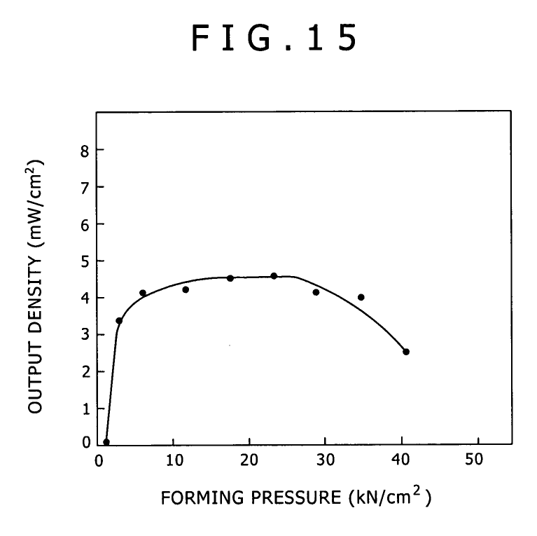

The electrodes produced in Examples 18 to 26 were examined for the characteristics as a fuel cell oxygen electrode catalyst. The output power densities at the time of power generation at an output voltage of 0.4 V are shown in Table 10 and FIG. 15.

TABLE 10

| | Pressure | Output density |
|---|---|---|
| | (kN/cm²) | (mW/cm²) |
| Example 18 | 1.4 | — |
| Example 19 | 2.8 | 3.4 |
| Example 20 | 5.6 | 4.1 |
| Example 21 | 11.3 | 4.2 |
| Example 22 | 17.0 | 4.5 |
| Example 23 | 22.6 | 4.6 |
| Example 24 | 28.2 | 4.1 |
| Example 25 | 34.0 | 4.0 |
| Example 26 | 39.6 | 2.5 |

In the process of Example 18, the pressure at the time of forming was too low to achieve the forming of the disk. The forming pressure at 22.6 kN/cm² gave the best output, and, when the pressure was higher than 22.6 kN/cm², the characteristic was worsened due to interruption of oxygen passages. Particularly, the pressure of more than 39.6 kN/cm² is unsuited to the production process according to the present invention. Therefore, for sufficiently displaying the effects of the present invention, the forming pressure is desirably in the range of 2.8 to 39.6 kN/cm², inclusive.

As has been described above, according to the examples of the present invention, even a catalyst low in efficiency such as a nitrogen-containing active carbide catalyst can be used as an oxygen electrode in a fuel cell, and the power generation characteristics of the fuel cell can be enhanced by appropriate selection of the thickness of the catalyst (the surface density of the catalyst), the mixing ratio of the perfluorosulfonic acid-based resin, the pressure applied at the time of forming, or the like; thus, power generation characteristics better than those achieved through the conventional application (coating) technique were obtained.

The embodiment and examples as above-described can be modified, as required, based on the technical thought of the present invention.

The catalyst according to the present invention contains the nitrogen-containing carbonaceous catalyst and the hydrogen ion conductive polymer material, so that gas molecules, hydrogen ions, and electrons can all pass in the inside of the catalyst respectively through the internal holes possessed by the carbonaceous material and the voids remaining in the catalyst, through the hydrogen conductive polymer material, and through the carbonaceous material. Thus, all the substances relating to the oxygen-reducing reaction can easily move between the outside and the inside of the catalyst. Therefore, not only the carbonaceous material located at the surface of the catalyst but also the carbonaceous material present in the inside of the catalyst can effectively display the catalytic action thereof.

The catalyst electrode according to the present invention is formed by forming (molding) the powdery mixture of the nitrogen-containing carbonaceous catalyst and the hydrogen ion conductive polymer material. Therefore, like in the case of the catalyst, all of gas molecules, hydrogen ions, and electrons can easily move between the outside and the inside of the catalyst electrode respectively through the internal holes possessed by the carbonaceous material and the pores remaining in the catalyst electrode, through the hydrogen ion conductive polymer material, and through the carbonaceous material. Accordingly, even the carbonaceous material present in the inside of the catalyst electrode can effectively display the catalytic action thereof.

Further, the catalyst electrode according to the present invention is formed under pressing and/or heating while using the hydrogen ion conductive polymer material as a binder, so that the thickness and the shape of the catalyst electrode are not limited as in the case of the coating method. Therefore, a catalyst low in volumetric efficiency can be made to display a sufficient catalytic action, by enlarging the thickness of the catalyst electrode, and it is possible to obtain a catalyst electrode higher in catalytic performance than a catalyst electrode having a thin catalyst layer produced by the conventional coating method. In addition, since the catalyst electrode itself has a stand-alone shape, a support is not needed, and it is easy to use in combination a plurality of catalyst electrodes differing in forming conditions.

The production method according to the present invention is a method of producing the catalyst electrode. Besides, according to the membrane-electrode assembly and the electrochemical device of the present invention, the characteristic features of the catalyst electrode can be effectively displayed on electrochemical reactions.

### INDUSTRIAL APPLICABILITY

The present invention is suitably applicable, for example, to oxygen electrode catalysts in polymer electrolyte fuel cells and phosphoric acid type fuel cells which are expected as the next-generation power generation system, can realize the fuel cells with a reduced consumption of platinum and at low cost, and can contribute to spread of the fuel cells.

1. A catalyst comprised of a material which contains carbon and nitrogen and in which the presence ratio of carbon relating to a shake-up process is controlled.

2. The catalyst as set forth in claim 1, which is an oxygen reduction catalyst for accelerating an oxygen-reducing reaction of the following formula:
O₂+4H⁺+→4e⁻→2H₂O,
which contains carbon and nitrogen as indispensable component elements, and in which the presence ratio of carbon relative to the shake-up process in the surface thereof is controlled.

3. A catalyst comprised of activated carbon so controlled that, in measurement of electron spin resonance, first unpaired electrons with a g value of 1.9930 to 2.0000 are contained in a spin density of not less than 3.1×10¹⁹/g, and second unpaired electrons with a g value of 2.0020 to 2.0026 are contained in a spin density of not less than 6.0×10¹⁴/g.

4. The catalyst as set forth in claim 3, wherein in said measurement of electron spin resonance, said first unpaired electrons show Pauli paramagnetism, and said second unpaired electrons show Curie paramagnetism.

5. The catalyst as set forth in claim 1 or 2, containing nitrogen atoms in an amount, in terms of atom number percentage in the surface thereof, of not less than 0.96 mol %.

6. The catalyst as set forth in claim 1 or 2, having at least one species of first nitrogen atoms having an N1s electron bonding energy of 398.5±0.5 eV, second nitrogen atoms having an N1s electron bonding energy of 401±0.5 eV, and third nitrogen atoms having an N1s electron bonding energy of 403.5±0.5 eV.

7. The catalyst as set forth in claim 6, containing, in terms of atom number percentage in the surface thereof, said first nitrogen atoms in an amount of not less than 0.22 mol %, said second nitrogen atoms in an amount of not less than 0.53 mol %, and said third nitrogen atoms in an amount of not less than 0.21 mol %.

8. A method of producing a catalyst, comprising the steps of baking a material containing carbon and nitrogen as component elements, and subjecting the resulting baked product to steam activation, wherein the presence ratio of carbon relating to a shake-up process and/or the spin density of first unpaired electrons with a g value of 1.9930 to 2.0000 and the spin density of second unpaired electrons with a g value of 2.0020 to 2.0026 are controlled.

9. A method of producing a catalyst as set forth in claim 8, wherein a mixture powder of a carbonaceous solid raw material and a nitrogen-containing organic compound or a nitrogen-containing organic polymer powder is baked, and the resulting nitrogen-containing carbide powder is subjected to steam activation, whereby an oxygen reduction catalyst comprised of a nitrogen-containing activated carbide is produced.

10. A method of producing a catalyst as set forth in claim 8, wherein said control is carried out by regulating the temperature of said baking.

11. A method of producing a catalyst as set forth in claim 9, wherein said control is carried out by regulating the mixing ratio of said carbonaceous solid raw material and said nitrogen-containing organic compound.

12. A method of producing a catalyst as set forth in claim 9, wherein said control is carried out by selection of said nitrogen-containing organic polymer compound material to be used.

13. A method of producing a catalyst as set forth in claim 9, wherein coal-derived binder pitch is used as said carbonaceous solid raw material.

14. A method of producing a catalyst as set forth in claim 9, wherein melamine or hydrazine is used as said nitrogen-containing organic compound.

15. A method of producing a catalyst as set forth in claim 9, wherein polyacrylonitrile, a melamine resin, nylon, gelatin, or collagen is used as said nitrogen-containing organic polymer compound.

16. A method of producing a catalyst as set forth in claim 8, wherein said baking and said steam activation is carried out in a high-purity nitrogen stream at a temperature of 1000° C.

17. An electrochemical device comprising a plurality of electrodes, and an ion conductor clamped between said plurality of electrodes, wherein at least one of said plurality of electrodes contains a catalyst as set forth in any of claims 1 to 7.

18. The electrochemical device as set forth in claim 17, configured as a fuel cell.

19. The electrochemical device as set forth in claim 18, wherein said catalyst is contained as an oxygen electrode catalyst.

20. A catalyst containing a nitrogen-containing carbonaceous catalyst for accelerating an oxygen-reducing reaction of the following formula:
O₂+4H⁺+4e⁻→2H₂O
and a hydrogen ion conductive polymer material.

21. The catalyst as set forth in claim 20, wherein said hydrogen ion conductive polymer is a perfluorosulfonic acid resin.

22. The catalyst as set forth in claim 21, wherein the mixing ratio of said perfluorosulfonic acid resin is from 5 to 30 mass %.

23. The catalyst as set forth in claim 20, wherein the mass of said nitrogen-containing carbonaceous catalyst per unit area is from 10 to 110 mg/cm².

24. A catalyst electrode formed by pressurizing and/or heating from a powdery mixture containing a nitrogen-containing carbonaceous catalyst for accelerating an oxygen-reducing reaction of the following formula:
O₂+4H⁺+4e⁻→2H₂O,
and/or a conductive material carrying said catalyst thereon, and a hydrogen ion conductive polymer material.

25. The catalyst electrode as set forth in claim 24, formed from said powdery mixture of said nitrogen-containing carbonaceous catalyst, said hydrogen ion conductive polymer material, and a conductive material.

26. The catalyst electrode as set forth in claim 24, formed under a forming pressure in the range of 2.8 to 39.6 kN/cm².

27. The catalyst electrode as set forth in claim 24, wherein said hydrogen ion conductive polymer is a perfluorosulfonic acid resin.

28. The catalyst electrode as set forth in claim 27, wherein the mixing ratio of said perfluorosulfonic acid resin is from 5 to 30 mass %.

29. The catalyst electrode as set forth in claim 24, wherein the mass of said nitrogen-containing carbonaceous catalyst per unit area is from 10 to 110 mg/cm².

30. A method of producing a catalyst electrode, comprising the steps of preparing a powdery mixture containing a nitrogen-containing carbonaceous catalyst for accelerating an oxygen-reducing reaction of the following formula:
O₂+4H⁺+4e⁻→2H₂O,
and/or a conductive material carrying said catalyst thereon, and a hydrogen ion conductive polymer material, and forming said powdery mixture by pressurizing and/or heating.

31. A method of producing a catalyst electrode as set forth in claim 30, comprising the steps of preparing said powdery mixture of said nitrogen-containing carbonaceous catalyst, said hydrogen ion conductive polymer material, and a conductive material, and forming said powdery mixture.

32. A method of producing a catalyst electrode as set forth in claim 30, wherein said forming is conducted under a pressure in the range of 2.8 to 39.6 kN/cm².

33. A method of producing a catalyst electrode as set forth in claim 30, wherein a perfluorosulfonic acid resin is used as said hydrogen ion conductive polymer.

34. A method of producing a catalyst electrode as set forth in claim 33, wherein the mixing ratio of said perfluorosulfonic acid resin is from 5 to 30 mass %.

35. A membrane-electrode assembly wherein a catalyst electrode as set forth in any one of claims 24 to 29 is joined to a hydrogen ion conductive membrane.

36. The membrane-electrode assembly as set forth in claim 35, wherein said hydrogen ion conductive membrane is clamped between said catalyst electrode and a hydrogen electrode.

37. An electrochemical device wherein a membrane-electrode assembly as set forth in claim 35 is used for an electrochemical reaction part.

38. The electrochemical device as set forth in claim 37, configured as a cell.

39. The electrochemical device as set forth in claim 38, wherein said cell is a fuel cell.
